(19) United States
(12) Patent Application Publication
(10) Pub. No.: US 2017/0256955 A1
(43) Pub. Date: Sep. 7, 2017

(54) Efficient Peak Current Management In A Multi-Die Stack

(71) Applicant: SanDisk Technologies Inc., Plano, TX (US)

(72) Inventors: Sravanti Addepalli, Benagaluru (IN); Sridhar Yadala, Bengaluru (IN)

(73) Assignee: SanDisk Technologies Inc., Plano, TX (US)

(21) Appl. No.: 15/099,496

(22) Filed: Apr. 14, 2016

(30) Foreign Application Priority Data
Mar. 2, 2016 (IN) 201641007351

(51) Int. Cl. H02J 4/00; H04L 12/40

(52) U.S. Cl. CPC H02J 4/00; H04L 12/40045

(57) ABSTRACT

Techniques for managing the distribution of power among competing electronic devices such as semiconductor die are presented. Each device may be connected to a common power supply and sources a current on a load bus based on an estimated current consumption of a next desired state. However, before doing this, the device performs an internal check to determine whether there is a sufficient available current. The device decreases a logical value of the system current specification by the increase in current which is desired. A resulting voltage (Vspec) is compared to a voltage of the load bus (Vcontact). If Vcontact<=Vspec, the device sources current on the load bus to signal other devices that the available current is reduced. If a conflict is detected with another device, an arbitration process is performed. A linear or binary search algorithm can be used based on a respective device priority.

### BACKGROUND

The present technology relates to power management in a semiconductor device.

In semiconductor technology, there is a limited supply of power which is available at a given time. In some cases, multiple die share a common power supply and require current to perform respective operations. If the requested current is not available, the operations may be corrupted or delayed.

### BRIEF DESCRIPTION OF THE DRAWINGS

FIG. 1 depicts an example of a set of multiple devices in communication with a host.

FIG. 2 depicts an example configuration in which the devices of FIG. 1 are connected to the power supply line 109 and the load bus 108b of FIG. 1.

FIG. 3 depicts an example configuration of one of the devices of FIG. 1 which includes a state machine 301 and an Icc detection circuit 302.

FIG. 4A depicts a logical value of available system current and a summed value of consumed system current at a device.

FIG. 4B depicts an example arrangement of the circuit 299 of FIG. 3.

FIG. 5A depicts another example arrangement of the circuit 299 of FIG. 3.

FIG. 5B depicts an example process at a device for deciding whether to enter a new state, consistent with FIG. 5A.

FIG. 6A is a table depicting example Bin_Peak_Icc states, consistent with FIG. 4A-5B.

FIG. 6B is a table depicting example Sys_Peak_Icc states, consistent with FIG. 4A-5B.

FIG. 6C is a table depicting a tradeoff between a number of states and a noise margin, consistent with FIGS. 6A and 6B.

FIG. 7A depicts an example peak Icc detection algorithm using an arbitration process.

FIG. 7B depicts an example of the process of FIG. 7A where a next state requires a lower Icc than a present state.

FIG. 7C depicts an example of the process of FIG. 7A where a next state requires a higher Icc than a present state and the requested current does not violate a system current specification.

FIG. 7D depicts an example of the process of FIG. 7A where a next state requires a higher Icc than a present state and the requested current violates a system current specification, so that an internal wait state is entered.

FIG. 7E depicts an example of the process of FIG. 7A where a next state requires a higher Icc than a present state and two die request a higher current simultaneously, so that an arbitration process is started.

FIG. 7F depicts an example of the process of FIG. 7E after a die achieves a pass status in the arbitration process.

FIG. 7G depicts an example of the process of FIG. 7E after a die achieves a fail state in the arbitration process.

FIG. 7H depicts an example of the process of FIG. 7E where the arbitration process uses a random delay.

FIG. 8A depicts a matrix showing example priorities based on device address and wait count for use in any arbitration process.

FIG. 8B1 depicts an example arbitration process consistent with FIG. 8A.

FIG. 8B2 depicts a time line of an arbitration process, consistent with FIGS. 8A and 8B1.

FIG. 8C depicts another example arbitration process consistent with FIG. 8A.

FIG. 8D depicts another example of an arbitration process.

FIG. 9A1 depicts a tree showing a priority threshold of selected (device, wait state) pairs in a binary search arbitration process where there are 32 possible (device, wait state) pairs.

FIG. 9A2 depicts a tree showing a priority threshold of selected (device, wait state) pairs in a binary search arbitration process where there are 16 possible (device, wait state) pairs.

FIG. 9B depicts an example binary search arbitration process consistent with FIGS. 9A1, 9A2 and 9C.

FIG. 9C depicts an example of the binary search arbitration process of FIG. 9A2.

FIG. 9D is a block diagram of a non-volatile memory system using single row/column decoders and read/write circuits, as an example of the die of FIG. 1.

FIG. 10 depicts a block of memory cells in an example configuration of the memory array 1000 of FIG. 9D.

FIG. 11 depicts an example waveform in a programming operation using program and verify voltages which are provided by a power supply.

FIG. 12 depicts example threshold voltage (Vth) distributions of memory cells for a case with eight data states, showing read and verify voltages which may be provided by a power supply.

### DETAILED DESCRIPTION

Techniques are provided for efficiently managing the use of a power supply among competing devices. In one approach, the devices are separate die (or chips) in a multi-die stack or other multi-die package. Corresponding apparatuses are also provided.

There are various examples of electronic devices which share a common power supply. One example is multiple die in a semiconductor circuit. The die have contacts or connection points to the power supply, such as a pin or bond pad. In one approach, the die are in respective packages and each package has a pin which connects to the power supply. In another approach, multiple die are in one package and each die has a bond pad which connects to a common pin in a package, and that pin connects to the power supply. The contacts of the die may therefore be internal to the package.

One example of a die is used in a memory device and includes an array of memory cells. Other examples of die comprise integrated circuits which do not include a memory array. The die may have pins or other contacts for other purposes such as inter-die communications. In semiconductor manufacturing, a die is the area of the silicon wafer on which a functional circuit is fabricated. Many hundreds of identical dies are fabricated on each wafer. The term “die” can represent a single area of the silicon wafer or multiple areas of the silicon wafer. The term “dice” can also represent multiple areas of the silicon wafer.

Other examples of devices include peripherals that share a common power line. Peripherals can include a PCI Express or PCIe (Peripheral Component Interconnect Express) card, which is a high-speed serial computer expansion bus, and USB (Universal Serial Bus) devices on a common USB bus. The techniques are applicable to electronic devices that share a common bus which provides power and has a power budget. Typically, each electronic device has a dedicated contact such as a pin or bond pad that is connected to the power supply.

The peak current specification of a device is the maximum amount of current which is available. When there are multiple current-consuming devices, the current should be efficiently allocated among the different devices. The peak current specification may be violated if there are simultaneous high current operations. This can lead to a malfunction in the devices. For example, for a memory die, a lack of sufficient current can lead to an error in a read or write operation. The peak current specification sets a limit on the number of devices that can operate in parallel, impacting the system performance.

One approach is to use a central controller to schedule operations in the devices. For example, the controller can delay a request to one die until after another die has completed a requested action. Scheduling can be done on a predictive basis by being aware of the total current requirement across dies or by monitoring the real time impact of peak current. However, this requires additional communication between the controller and the devices and increases the processing burden of the controller. Moreover, the device may require an additional contact to receive a synchronizing signal from the controller. Thirdly, the controller cannot access internal operations of a die which are sequenced by the on-chip state machine. Even if the controller skews certain operations such as read/program/erase on different dies, the internal high current operations may again align in time causing violation in system ICC specification. Basically, the controller cannot predict the timing of internal high current operations for a given command.

Techniques for on-chip management of peak current are proposed herein which address the above and other issues. In one aspect, each device in a set of devices independently determines whether there is a sufficient amount of system current to enter a higher-current state. An initial determination can be made based on the available system current and an estimate of the current consumed in the higher-current state. This initial determination can be made internally within the device without initially affecting a load bus which is shared among the die. If the initial determination is successful, the device sources (adds or pulls up) a current on the load bus to signal to other devices that there will be a reduction in the available system current. The amount of current is equal to an estimated current consumption of the higher-current state. In case of a conflict with another device which concurrently sources current to the load bus, each device can independently perform an arbitration process to resolve the conflict. Example arbitration processes include linear and binary search algorithms in which each device has a priority based on its address and a count of a number of times it failed in the arbitration process. This can include random delay based arbitration also, as an example.

If the initial determination of whether there is additional available system current to enter a higher-current state is unsuccessful, the device enters a wait state and does not source an additional current on the load bus. This reduces the probability of conflicts, allowing the device to enter the higher-current state sooner. Performance can be improved by enabling more devices to operate in parallel and by reducing wait time for scheduling of internal operations. Various other features and benefits will be apparent in view of the following discussion.

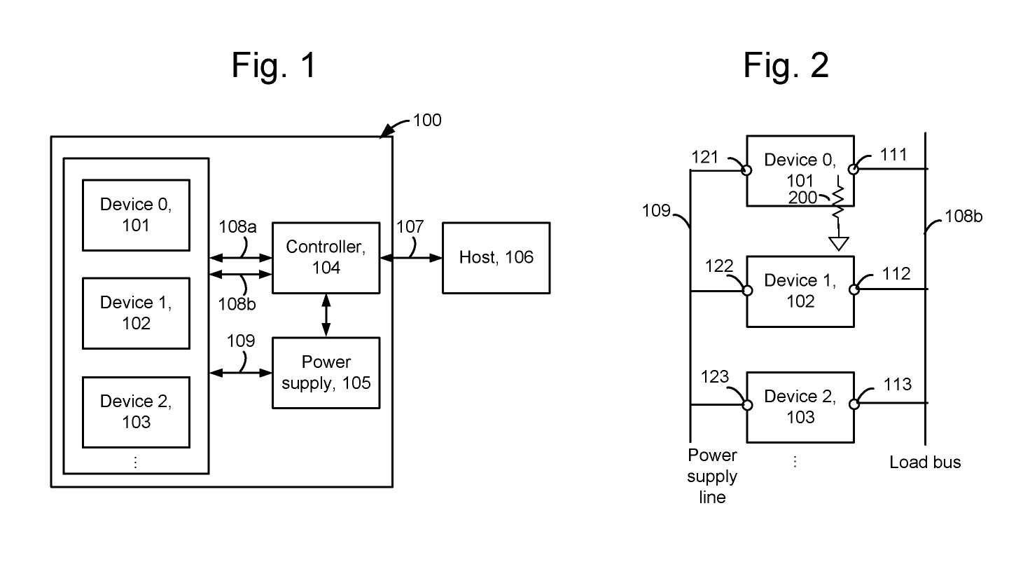

FIG. 1 depicts an example of set of multiple devices 100 in communication with a host 106. The package includes example device 0 (101), device 1 (102) and device 2 (103). A controller 104 communicates commands to the devices, such as to state machines, via data and control lines 108a. The controller is external to the devices. The controller may also set a pull up/pull down current/resistive load on a load bus 108b. In an alternate configuration, the load bus 108b may connect only to the devices and may not be connected to the controller. A power supply 105 provides power/current to the devices via a common power supply line 109. The control lines 108a provide a backend interface. The controller communicates with the host via a path 107 which is a frontend interface.

In one approach, the devices are die which are connected in a stack and share common I/O pins and a power bus. The number of dies can be, e.g., 4, 8, 16 or 32. Some systems could have decimal die stacks. This system connects to a host through a frontend interface. A goal is to manage the operations across devices so as to control the peak current consumption from the common power supply which is shared across all devices and the controller.

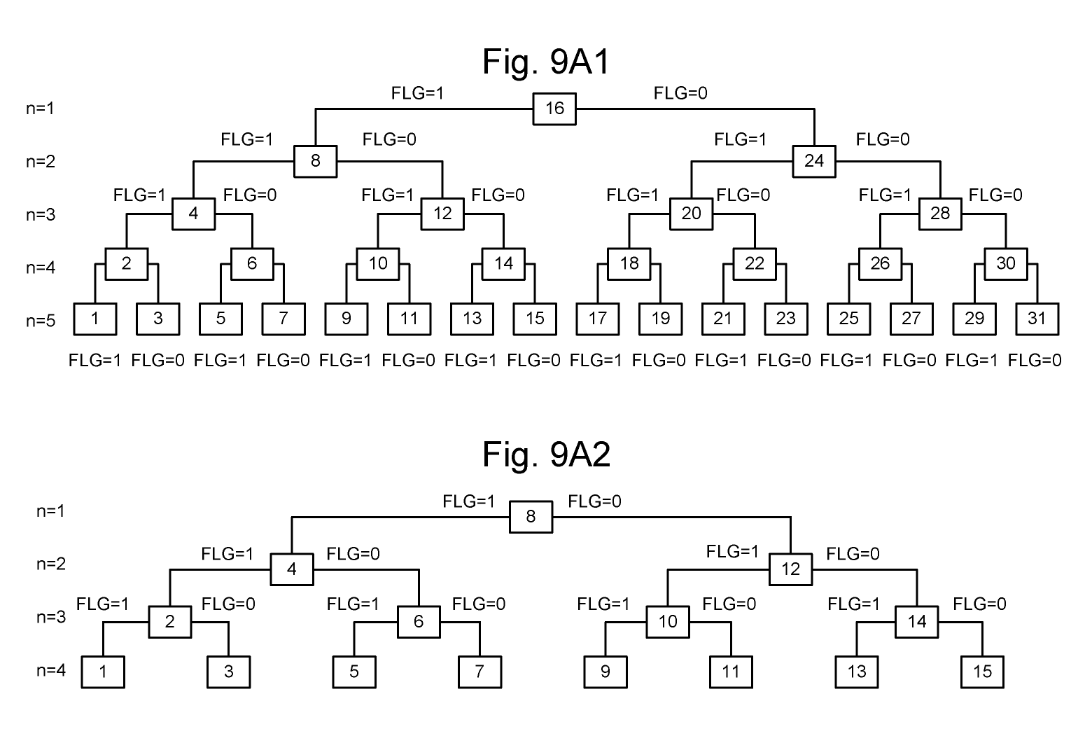

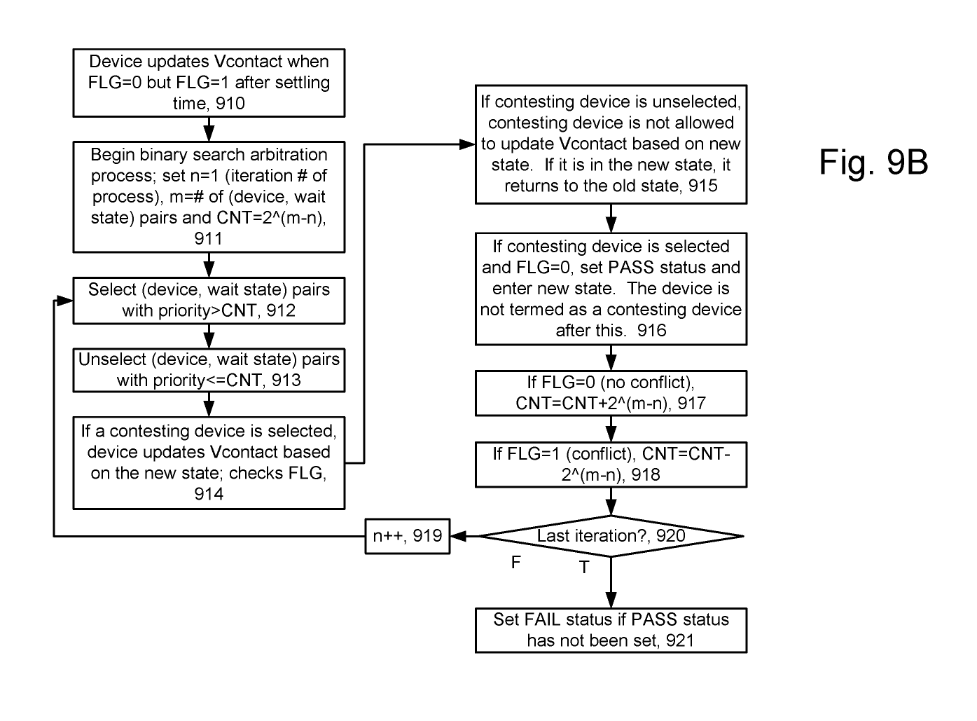

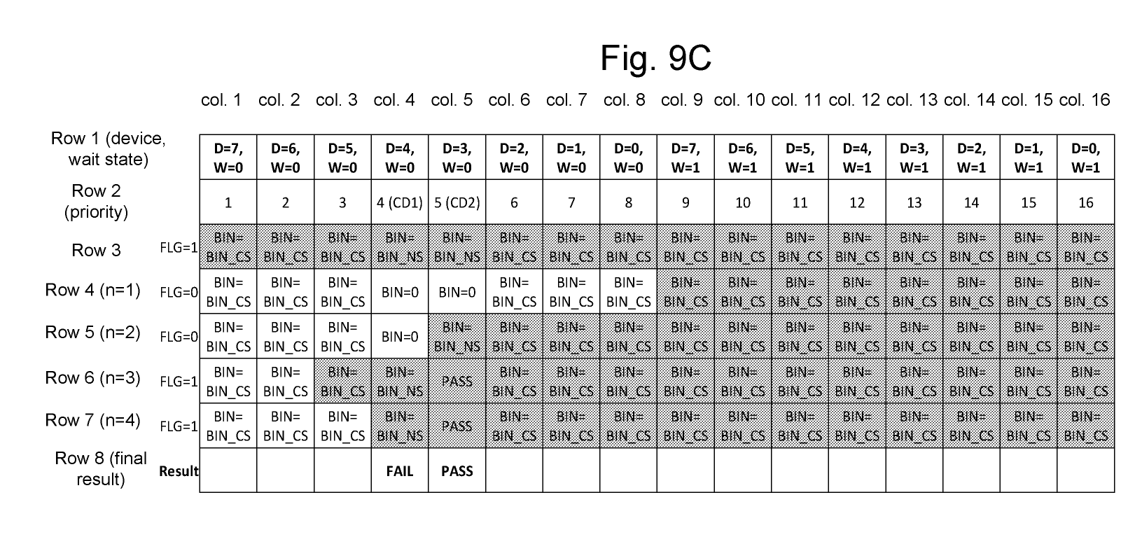

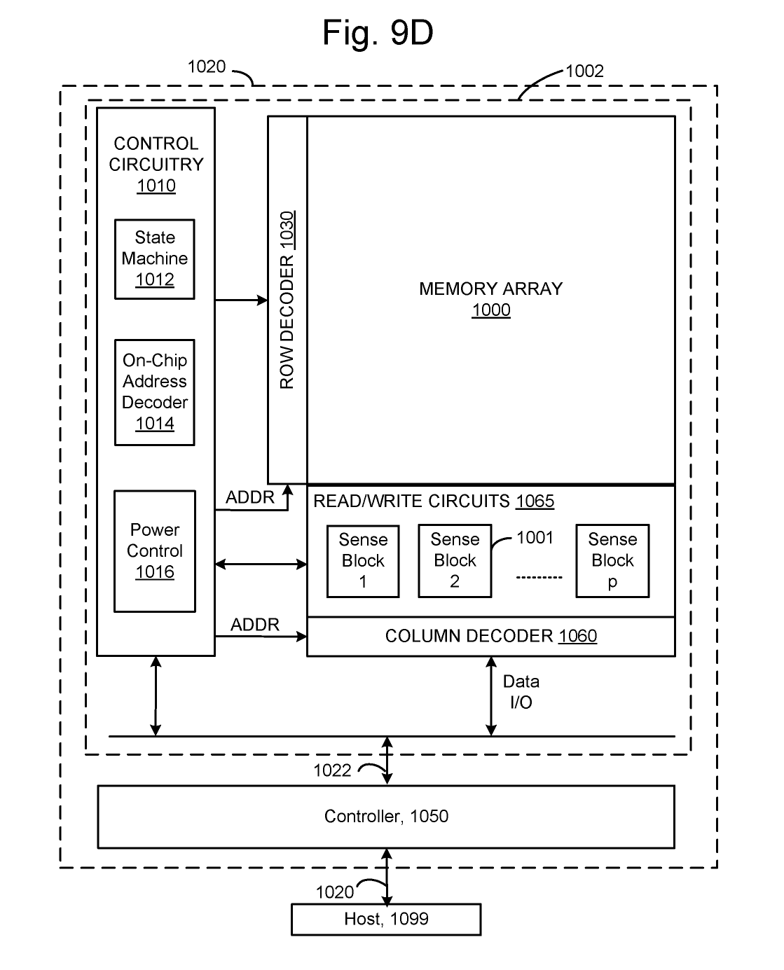

In one approach, each device comprises input/output (I/O) contacts to receive/transmit commands and data, contacts for support functions (e.g., power, chip enable), other contacts which may be used only in test modes, an on-chip state machine which controls the internal operations of the chip, and other supporting circuits such as regulators, charge pumps, and oscillators. In one example, memory device includes a memory array to store data, and data path circuits to read/write data from I/O circuits to the memory array. One example of a memory device comprises memory cells arranged in a NAND configuration. See also FIG. 9D.

Each device may have a contact which communicates information regarding the current consumed by the device to all other devices. Each device may have a current detection circuit which judges whether the total current of all devices is within a peak current specification limit. An on-chip state machine may be provided which uses a flag output from the current detection circuit to schedule the internal operations of the device.

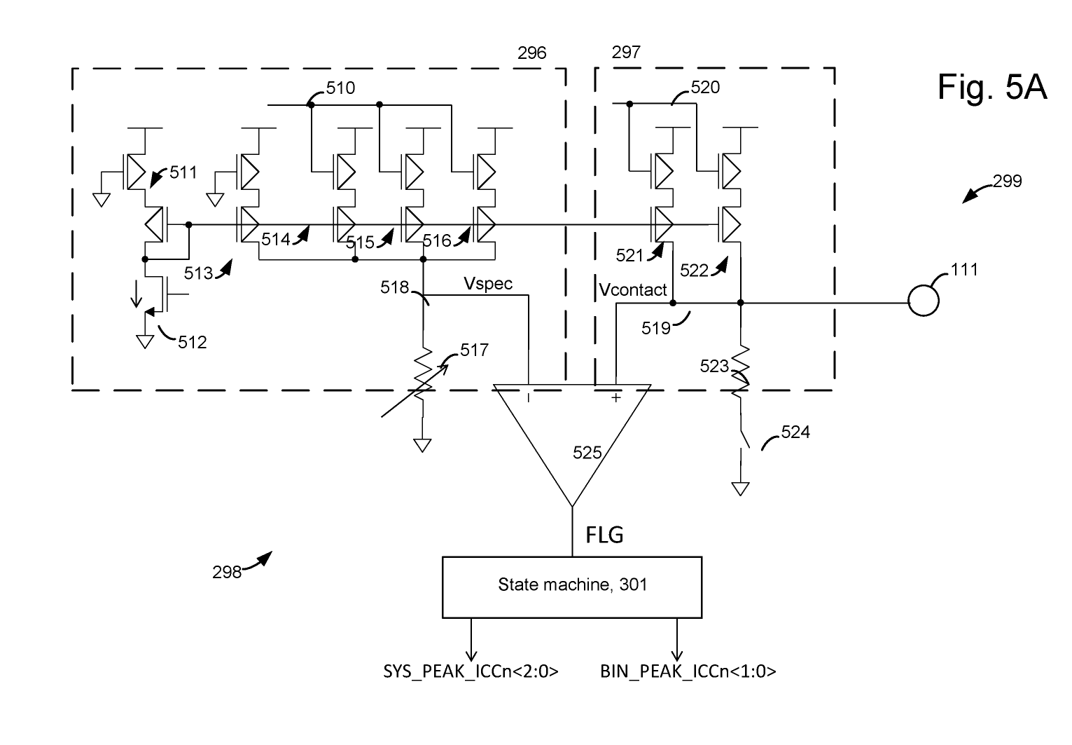

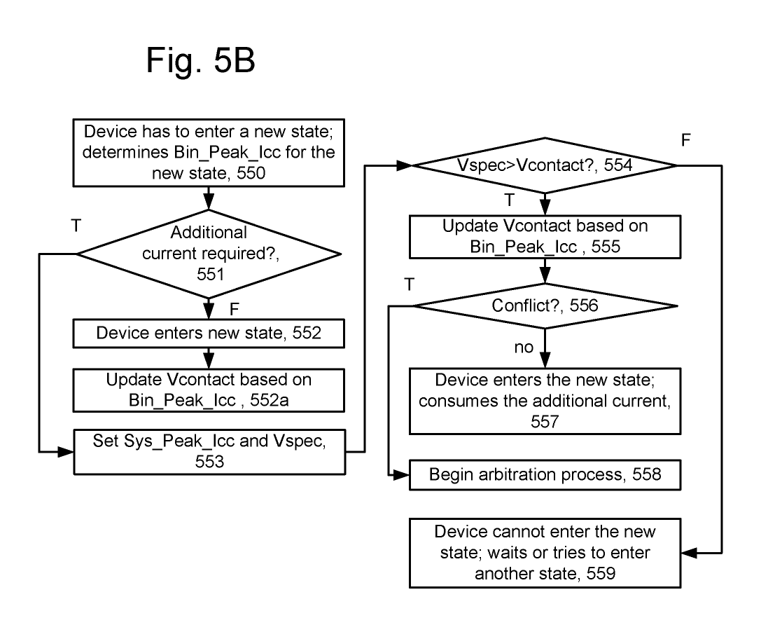

FIG. 2 depicts an example configuration in which the devices of FIG. 1 are connected to the power supply line 109 and the load bus 108b of FIG. 1. The load bus and the power supply line are common to multiple devices. Device 0 (101), device 1 (102) and device 2 (103) have a contact 111, 112 and 113, respectively, which connects to the load bus 108b, and a contact 121, 122 and 123, respectively, which connects to the power supply line 109. A resistor load 200 may be provided in one of the devices to provide a pull down current on the load bus. See FIG. 5A. That is, the resistive load adds a pull down current to the load bus. As mentioned, each die can source a current onto the load bus based on an estimate of the current which is needed by the die in a present state or a next, higher-current state.

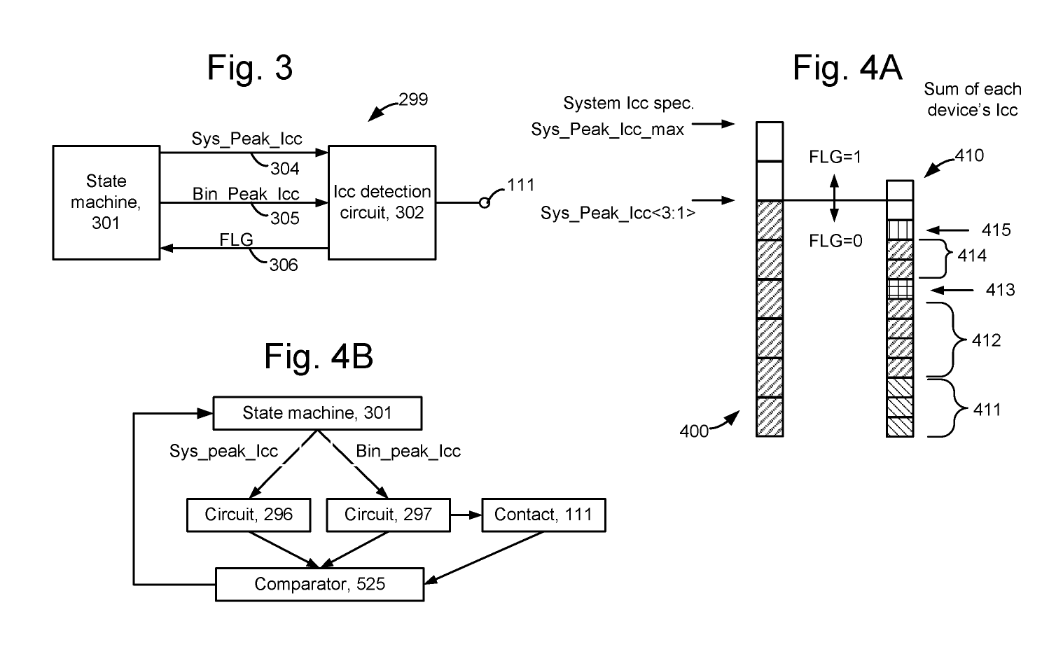

FIG. 3 depicts an example configuration of one of the devices of FIG. 1 which includes a state machine 301 and an Icc detection circuit 302 as part of a circuit 299. The state machine provides chip-level control of operations. The state machine, also referred to as a finite state machine, is an abstract machine that can be in one state, at a given time, among a finite number of available states. In one approach, the machine is in only one state at a time, and can transition from one state to another when initiated by a triggering event or condition. A particular state machine can be defined by a list of its states, and the triggering condition for each transition. A state machine may be implemented, e.g., using a programmable logic device, a programmable logic controller, logic gates and flip flops or relays. A hardware implementation may use a register to store state variables, a block of combinational logic that determines the state transition, and a second block of combinational logic that determines the output of the state machine. A state machine can carry out lower-level processes relative to the external controller in a space-efficient manner. A state machine has a present state, and there may be one or more next states which can follow a given present state.

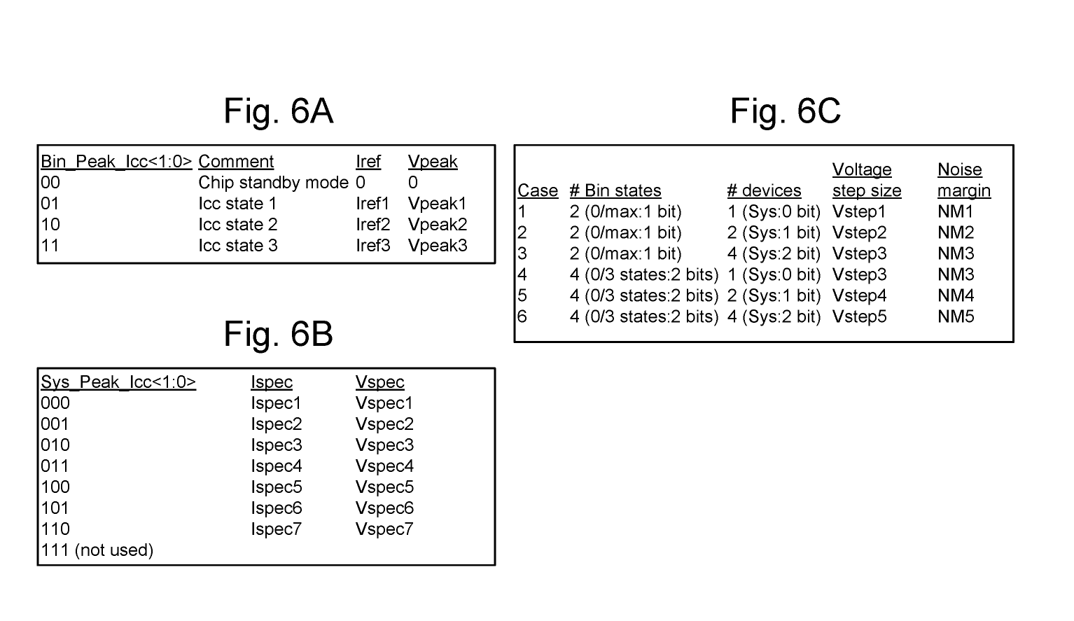

The state machine may provide logical values such as Sys_Peak_Icc and Bin_Peak_Icc on paths 304 and 305, respectively, to the Icc detection circuit. The Icc detection circuit may provide a flag FLG to the state machine on a path 306. Sys_Peak_Icc is the peak current specification of the power supply on the power supply line. This may be unique to a given system. Icc denotes current. Sys_Peak_Icc can be a three-bit value which is provided to the state machine by the controller. All the die or other devices connected in a die stack or other configuration can have the same value of Sys_Peak_Icc. See FIGS. 5A and 6B. For different systems or multi-die stack configurations, Sys_Peak_Icc can be set to different values by the controller to provide a comparison voltage Vspec which is compared with the pin voltage Vcontact, as depicted in FIG. 5A. FLG is set based on the comparison.

Bin_Peak_Icc is an estimate made by the state machine of the current consumption of a present or future (next desired) state of the device. The state machine may have information such as a table which associates an estimated current consumption with each state of a plurality of available states that the state machine may enter. The state machine knows the present state and, in some cases, the next desired state. The functionality of the state machine could be performed by another entity such as a microcontroller. Bin_Peak_Icc can be a two-bit value such as depicted in FIGS. 5A and 6A. In one approach, the current indicated by Bin_Peak_Icc is not real time; it is based on silicon measurement/simulation data from a device in a typical process. The contact 111 is connected to all devices in the stack which share a common power supply line or power bus. The voltage of each contact represents the sum of the Icc states of all devices.

FIG. 4A depicts a logical value of available system current and a summed value of consumed system current at a device. Sys_Peak_Icc is set by the controller. This can be less than the maximum value (Sys_Peak_Icc_max) as depicted. In the eight blocks 400, six of the blocks are shaded and these represent the current specification for the given system. Two of the blocks are unshaded and these represent the difference between maximum possible specification of Sys_Peak_ICC and the specification for the given system. FLG=1 if the sum of the currents of the devices exceeds Sys_Peak_Icc, and FLG=0 if the sum of the currents of the devices does not exceed Sys_Peak_Icc.

In the thirteen blocks 410, eleven of the blocks are shaded and these represent the current consumed by different devices. A common voltage on the load bus is sensed by the contact of each device, where this voltage is proportional to a sum of the currents in the multiple devices. For example, the blocks 411 represent Bin_Peak_Icc<1:0> in device 0, the blocks 412 represent Bin_Peak_Icc<1:0> in device 1, the block 413 represents Bin_Peak_Icc<1:0> in device 2, the blocks 414 represent Bin_Peak_Icc<1:0> in device 3 through device n−1, and the block 415 represents Bin_Peak_Icc<1:0> in device n. Each block represents a unit of current.

FIG. 5A depicts another example arrangement of the circuit 299 of FIG. 3. The circuit includes the state machine, a circuit 296 which provides a comparison value, a circuit 297 which provides a current source (pull up), in communication with the contact 111, and a comparator 525. The circuit 296 provides a comparison value to the comparator 525, such as a voltage (e.g., Vspec in FIG. 5A) or current, based on a system specification current Sys_peak_Icc provided by the state machine. The circuit 297 provides a current source for the contact 111. The contact is also connected to the comparator. The comparator compares the comparison value to a value of the contact. For example, the values may be currents or voltages.

FIG. 5A depicts another example arrangement of the circuit 299 of FIG. 3. In the circuit 299, a comparison circuit 298 includes the circuits 296 and 297 and the comparator 525 of FIG. 4B. Circuit 296 of the comparison circuit sets Vspec. Circuit 297 of the comparison circuit sets a current which is sourced onto the contact 111.

As part of the comparison circuit, the comparator 525 receives Vspec at one input and Vcontact at another input. If Vspec>=Vcontact, FLG=0. If Vspec<Vcontact, FLG=1. The comparator includes an inbuilt offset to ensure that FLG=0 when Vspec=Vcontact. FLG is input to the state machine 301. Outputs of the state machine include multi-bit codes including Sys_Peak_Icc<2:0> and Bin_Peak_Icc<1:0>. Sys_Peak_Icc<2:0> is provided on a path 510. With a three bit value, one bit is provided to transistors 514, another bit is provided to transistors 515 and another bit is provided to transistors 516 to set a current at a node 518. An additional current branch may be included as part of 513 to introduce an offset to the comparator. This ensures that the comparator gives an output of FLG=0 when Vspec=Vcontact. Vspec is provided based on this current and a resistor 517. Transistors 511 and 512 are used to generate a current which is mirrored to transistors 513. The gate of transistor 512 is an analog voltage which is generated by using an NMOS diode connected transistor in series with an on-chip current source. In one configuration, this on-chip current source may be temperature compensated for higher accuracy.

The adjusted system specification current (Sys_Peak_Icc<2:0>) is represented by a multi-bit code; and the comparison circuit is configured to generate a current based on each bit of the multi-bit code and sum the currents to provide the comparison voltage at an input to a comparator. For example, currents generated by the transistors 514, 515 and 516 are summed at the node 518. A current generated by the transistors 513 are also summed at the node 518. The resistor may be adjustable and trimmed. Vspec may be proportional to Sys_Peak_Icc<2:0>.

The comparator may have a wide input common mode voltage range, and may be designed to compare the voltage on the contact with the reference voltage, Vspec. The comparator may operate across a common mode range of, e.g., 0.5 V to 1.5 V. The output of the comparator (FLG) is an input to the on-chip state machine which does the scheduling of internal operations.

Bin_Peak_Icc<1:0> is provided on a path 520. With a two bit value, one bit is provided to transistors 521, and another bit is provided to transistors 522 to set a current at a node 519. This is a source current of the contact 111 which represents an estimate of the current used by the device in the present state or next state of the device. This current increases the current on the load bus and contact. Vcontact is the voltage of the contact and load bus.

The contact which is connected to all devices in the stack may have a pull down resistor (e.g., 2 kΩ) 523 in one of the devices. Using a switch 524, the resistor can be connected on the device with chip address 0. Each device dumps a current on this node. The magnitude of this current is proportional to the Icc state of the device in a present state or a next state (represented by Bin_Peak_Icc).

This current may be generated by mirroring a constant current with a zero temperature coefficient. A zero temperature coefficient current reference is generally available on-chip for other operations. In case a current source with a zero temperature source is not available on-chip, a current reference without temperature compensation can be used. This introduces a minimal error as the temperature variation across devices for a given system would not be much. (+/−1% error for a temperature difference of +/−5° C. across devices)

The voltage level on the contact (Vcontact) is proportionate to the sum of currents dumped on this node by each device. Hence it is proportionate to the sum of Icc consumed by each device. This voltage is compared to a reference voltage (Vspec) to judge whether or not the total system current is within the specification.

The state machine, to source current onto the load bus, is configured to generate a multi-bit or single-bit word (Bin_Peak_Icc<1:0>) representing the current consumption of the next state, to generate a current based on each bit of the multi-bit code and sum the generated currents. For example, currents generated by the transistors 521 and 522 are summed at the node 519.

The reference voltage is internally generated on each device. Each device has a pull down resistor connected to this node. The value of this resistor is chosen to be ten times that of the resistor connected to the contact (e.g., 20 kΩ). This is done to reduce current consumed by the Icc detection circuit on each device. It is trimmed to a value of 20 kΩ during testing in order to eliminate process variations. Temperature variations can be ignored as the temperature variation across devices is expected to be minimal.

A constant current proportionate to the system Icc specification is dumped on this node. The current is mirrored from a constant current source and is proportionate to Sys_Peak_Icc. A half LSB current is always dumped on this node when the circuit is on. This ensures that when current dumped on Vspec is exactly equal to Vcontact, FLG=0 so that there is no ambiguity in output level. It also reduces the reference error to +/− half LSB. Without this, error is 0 to −1 LSB.

This circuit compares an internal voltage, Vspec, to a voltage on a contact. In other cases, another value such as a current can be compared. Generally, each device may have a comparison circuit to compare a comparison value to a value of such a contact.

FIG. 5B depicts an example process at a device for deciding whether to enter a new state, e.g., a next state, consistent with FIG. 5A. At step 550, the device (e.g., state machine) has to enter a new state, e.g., based on the sequencing of a state machine of the device, and determines Bin_Peak_Icc for the new state. Generally, the states of a device are decided by the state machine which is internal to the device. The device may receive a high level command such as to write data to a memory array. In response to the command, the state machine will perform a sequence of lower level actions such as applying program pulses to a word line and performing verify operations. The state machine decides when to transition between states, e.g., enter a next state, independently of an external controller. The internal operations of each state machine are typically not known to the external controller. As a result, de-centralized management of peak Icc using techniques described herein is advantageous.

It is also possible for the state machine to enter a new state on its own. A decision step 551 determines if additional current is required. This can involving determining if Bin_Peak_Icc(new)>Bin_Peak_Icc(present). If decision step 551 is false, the device directly enters the new state at step 552 and, at step 552a, updates Vcontact by applying a current based on Bin_Peak_Icc. This is a smaller current than used for the previous state so that Vcontact will decrease, signaling to the other devices that additional current is available.

If decision step 551 is true, step 553 sets Sys_Peak_Icc and Vspec is updated accordingly. In one approach, the present value of Sys_Peak_Icc is decreased by the amount of the additional current (Bin_Peak_Icc(new)−Bin_Peak_Icc(old)). Sys_Peak_Icc is used to set Vspec, as discussed. At decision step 554, if Vspec>Vcontact, the device updates Vcontact at step 555 by applying a current based on Bin_Peak_Icc at step 555. This is a larger current than used for the old state so that Vcontact will increase, signaling to the other devices that less current is available. A decision step 556 determines whether there is a conflict with one or more other devices also requesting additional current. For example, a conflict may occur when another device updates its contact to consume more current at the same time. A conflict may be detected by monitoring FLG and observing that FLG transitions from 0 to 1 within a specified time period, e.g., a contact voltage settling time, after initially updating Vcontact. If decision step 556 is false, step 557 is reached, where the device enters the new state and consumes additional current. If decision step 556 is true, an arbitration process begins at step 558. If decision step 554 is false, the device cannot enter the new state and waits, or tries to enter another state, at step 559.

For example, the device may try to enter another state which consumes additional current relative to the present state but not as much current as the state which it unsuccessfully tried to enter. For instance, the state which it unsuccessfully tried to enter may involve a programming operation for memory cells, where the cells are programmed in a certain time period. The another state may also involve programming but at a slow rate. Or the another state may involve a programming operation for lower data states which consumes less current than programming of higher data states. Or the another state may involve a refresh programming operation rather than a full programming operation.

As an example, assume that the current available to the set of devices is 100 units (e.g., microamps). Sys_Peak_Icc can then be set initially to 100 units. Assume also that a device is in a present state which consumes 20 units of current and wishes to enter a new state which consumes 40 units of current. As a result, 40−20=20 additional units of current are desired. The device lowers Sys_Peak_Icc to 100−20=80 units, sets Vspec accordingly and compares Vspec to Vcontact. Assume Vcontact is at a voltage V1 which corresponds to 75 units of current. Since Vspec>Vcontact (80>75), FLG=0 and the device can proceed to the new state. In a further example, assume Vcontact is at a voltage V2 which corresponds to 85 units of current. Since Vspec<Vcontact (80<85), FLG=1 and the device cannot proceed to the new state.

However, assume there is another new state which consumes 30 units of current. The device can determine if entering this state is feasible. Here, 30−20=10 additional units of current are desired. The device lowers Sys_Peak_Icc to 100−10=90 units, sets Vspec accordingly and compares Vspec to Vcontact. Assume Vcontact is at the voltage V2 which corresponds to 85 units of current. Since Vspec>Vcontact (since 90>85), FLG=0 and the device can proceed to this new state.

The techniques described herein maximize the number of devices that can operate in parallel by considering the actual current consumption state of each device rather than considering the highest possible current consumption of a device. Moreover, the devices act in a decentralized way by deciding when they can enter a higher-current state. This frees the controller from issuing a suspend command to a device, for instance, if the voltage of the power bus drops below a certain level and a subsequent resume command when the voltage of the power bus increases. Other current-saving measures such as issuing a slow-down command to slow down the state machine clock or a charge pump clock, for instance, can also be avoided. Moreover, in some cases, a slow-down command cannot be used and the supply voltage may drop below a permissible limit resulting in data loss.

The use of a centralized arbitrator can also be avoided. Current consumed by each device can be digitally communicated to an arbitrator which may be present in the controller, for instance. However, this can result in frequent suspension of operations and degraded performance. Further, priority cannot be first come, first serve.

By adjusting Vspec to reflect the additional current consumption of the next state and comparing Vspec to Vcontact before adjusting Vcontact, in an internal check, the adjustment to Vcontact can be avoided in some cases, e.g., step 559. In contrast, omitting the internal check, directly updating Vcontact to reflect the additional current consumption and comparing this updated Vcontact to a fixed reference voltage can have disadvantages. For example, if two or more devices request a higher current and update their contacts accordingly at the same time, neither device is allowed to go to the higher-current state. Each device can retry going to a higher-current state after a fixed random time, but this increases the wait time. This wait time increases in proportion to the number of devices in the stack times and the time for the contact voltage to settle. Moreover, when Vspec exceeds the adjusted Vcontact, it is unknown to the device whether two or more devices are requesting additional current at the same time, or whether the additional current requested by one device alone exceeds the available current. This increases wait time, resulting in a performance impact.

FIG. 6A is a table depicting example Bin_Peak_Icc states, consistent with FIG. 4A-5B. As mentioned, a two bit value or multi-bit code may be used to represent four types of current consumption states, as an example. In practice, one or more bits can be used. The number of bits in Bin_Peak_Icc can be decided based on the number of Icc states required in each device. LSB current for Bin_Peak_Icc is a tradeoff between the Icc budget for this circuit and the noise margin on the load bus 108b.

In this example, Bin_Peak_Icc=00 corresponds to a chip standby mode in which a reference current Iref=0 V and a peak voltage Vpeak=0 V. Bin_Peak_Icc=01 corresponds to a first Icc state in which Iref=Iref1 and Vpeak=Vpeak1. Bin_Peak_Icc=10 corresponds to a second Icc state in which Iref=Iref2 and Vpeak=Vpeak2. Bin_Peak_Icc=11 corresponds to a third Icc state in which Iref=Iref3 and Vpeak=Vpeak3. Iref3>Iref2>Iref1 and Vpeak3>Vpeak2>Vpeak1.

FIG. 6B is a table depicting example Sys_Peak_Icc states, consistent with FIG. 4A-5B. The number of Sys_Peak_Icc bits is decided based on the desired resolution of the reference voltage (Vspec) and number of states required in the system Icc specification. In this example, Sys_Peak_Icc=000, 001, 010, 011, 100, 101 and 110 are multi-bit codes which correspond to a state in which Ispec=Ispec1, Ispec2, Ispec3, Ispec4, Ispec5, Ispec6 and Ispec7, respectively, and Vspec=Vspec1, Vspec2, Vspec3, Vspec4, Vspec5, Vspec6 and Vspec7, respectively. Ispec7>Ispec6>Ispec5>Ispec4>Ispec3>Ispec2>Ispec1 and Vspec7>Vspec6>Vspec5>Vspec4>Vspec3>Vspec2>Vspec1.

FIG. 6C is a table depicting a tradeoff between a number of states and a noise margin, consistent with FIGS. 6A and 6B. There are six example cases. For each case, a first column indicates the case, a second column indicates a number of current consumption states (Bin_Peak_Icc), a third column indicates a number of device allowed to operate simultaneously in a high current state, a fourth column indicates a voltage step size on the contact, and a fifth column indicates a noise margin. For cases 1-3, there are two states identified by one bit. For cases 4-6 there are four states identified by two bits. For case=1, the number of devices is one, Sys_Peak_Icc is identified by 0 bits, the voltage step size is Vstep1 and the noise margin is NM1. For case=2, the number of devices is two, Sys_Peak_Icc is identified by 1 bit, the voltage step size is Vstep2 and the noise margin is NM2. For case=3, the number of devices is four, Sys_Peak_Icc is identified by 2 bits, the voltage step size is Vstep3 and the noise margin is NM3.

For case=4, the number of devices is one, Sys_Peak_Icc is identified by 0 bits, the voltage step size is Vstep3 and the noise margin is NM3. For case=5, the number of devices is two, Sys_Peak_Icc is identified by 1 bit, the voltage step size is Vstep4 and the noise margin is NM4. For case=6, the number of devices is four, Sys_Peak_Icc is identified by 2 bits, the voltage step size is Vstep5 and the noise margin is NM5. Vstep5<Vstep4<Vstep3<Vstep2<Vstep1 and NM5<NM4<NM3<NM2<NM1. A larger noise margin is preferable.

The contact is shared across all devices and may have a capacitance of a few pF. The contact settling time may be up to about 500 nsec, for instance, across all voltage ranges and step sizes. The contact settling time is the time for a voltage at the contact to settle after changing.

Advantageously, in some embodiments, only one external pad is required for communicating Icc information among all the devices. The on-chip state machine provides information on the peak Icc specification for the system through Sys_Peak_Icc<2:0> and the Icc requirement of the next state through Bin_Peak_Icc<1:0>. The external pad has an on-chip trimmed pull down resistor (Rcontact) connected on device 0. Each of the devices in the stack sources a fixed current on to the contact, where the magnitude of this current depends on the magnitude of Icc in the current/next operation. The voltage on this contact is a result of a sum of currents sourced by all the devices. This voltage is compared with a reference voltage (Vspec) on each device to provide a measure of whether sum of Icc of all devices is within the system specification. Further, a reference voltage is generated by having an on-chip trimmed resistor on each of the devices. The resistor magnitude is a multiple of a resistor on the contact. This ensures that trim settings can be shared between these two resistors. The trimming process need not be repeated. The on-chip state machine processes the output flag of the comparator to decide whether the next operation can be done, or whether it needs to wait and/or enter an arbitration process such as described below.

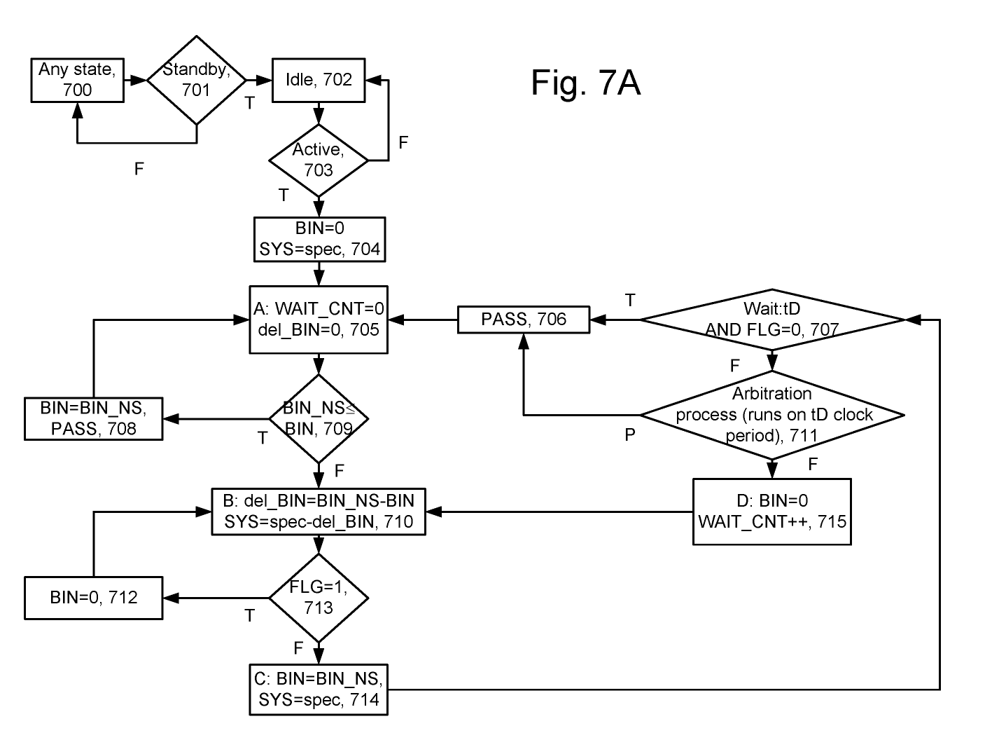

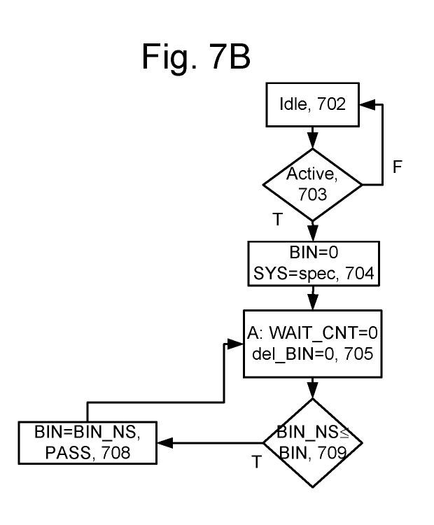

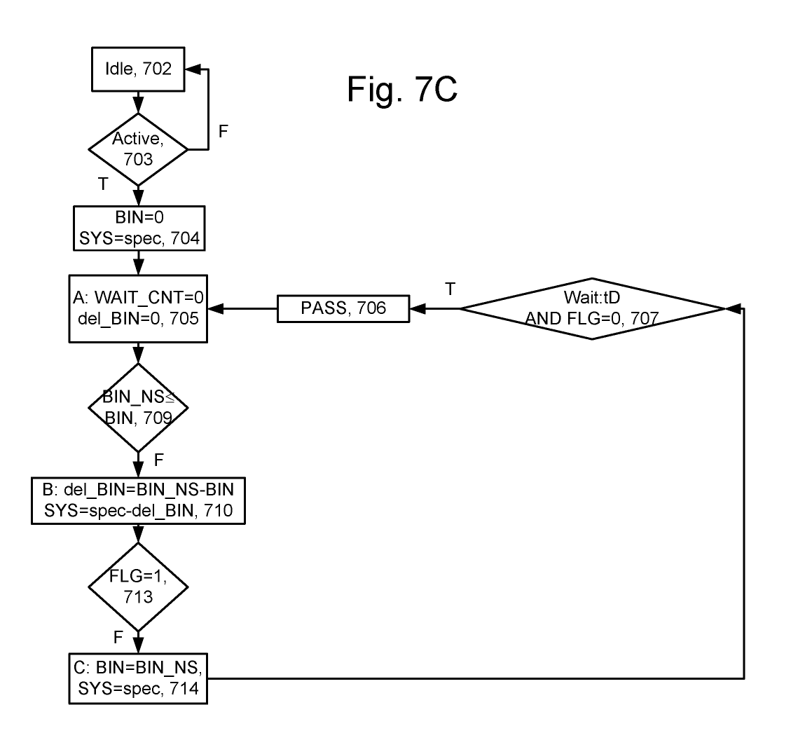

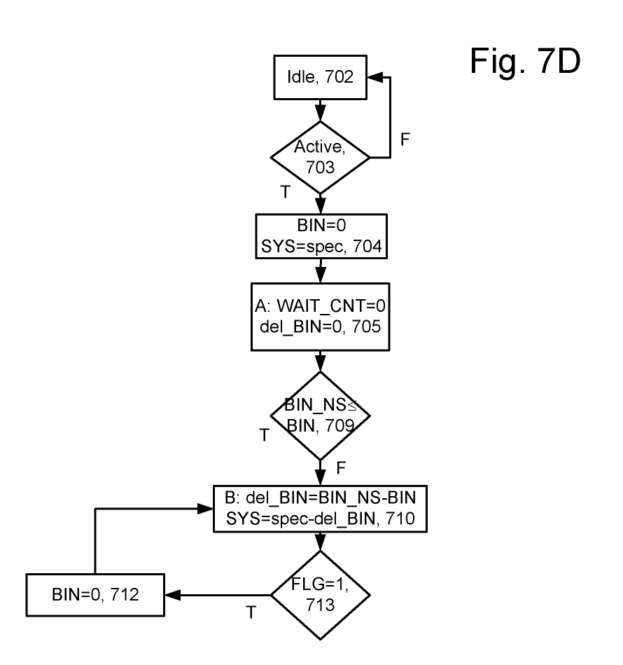

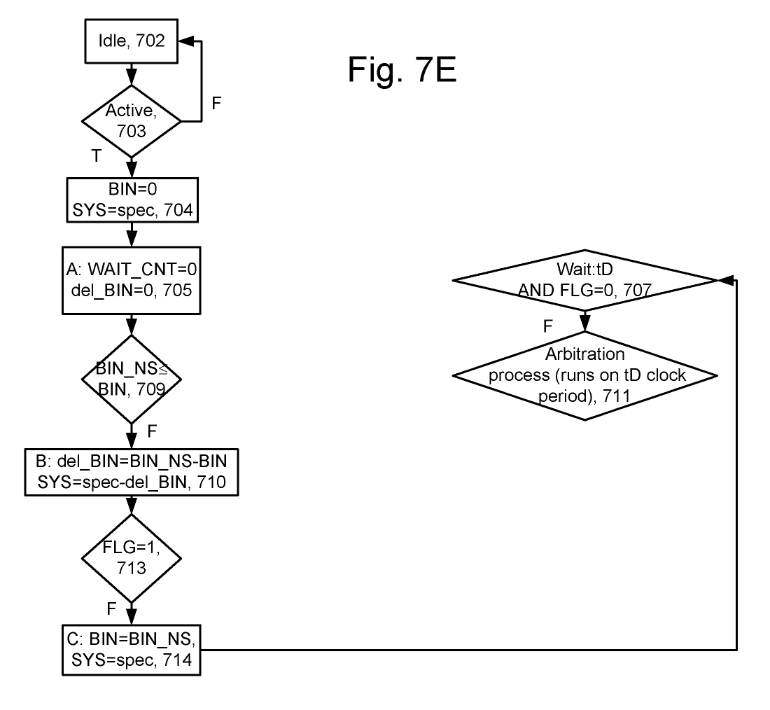

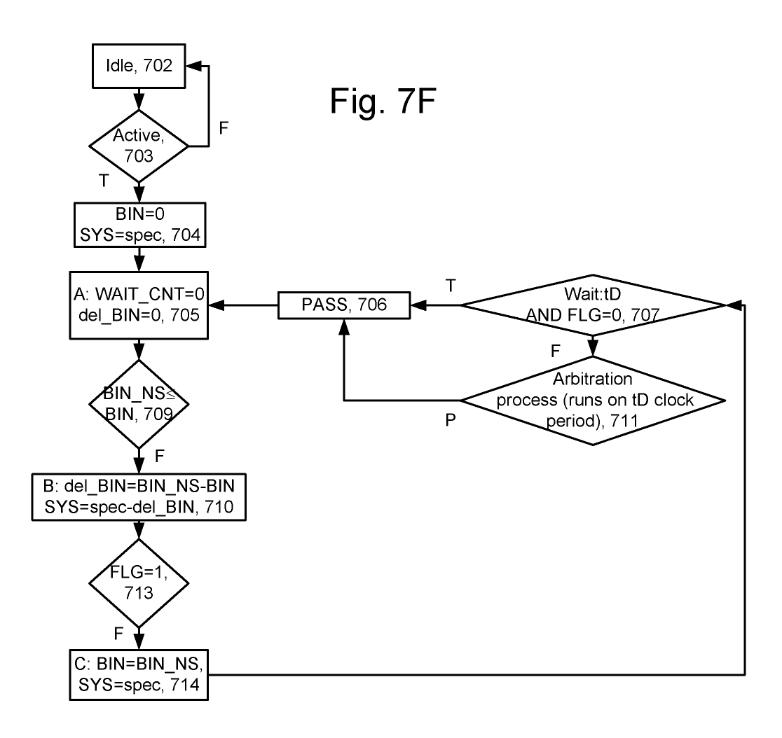

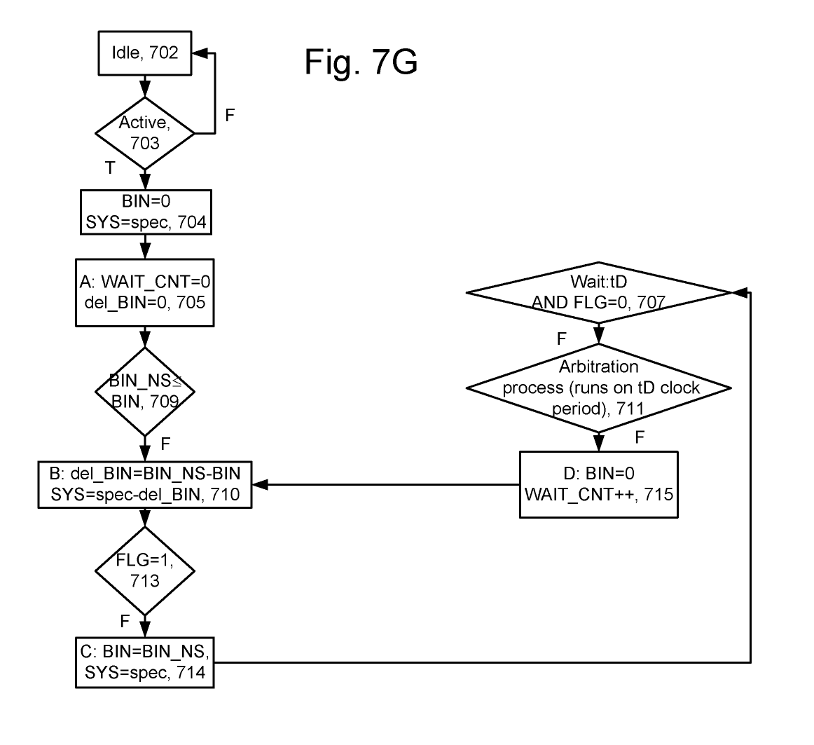

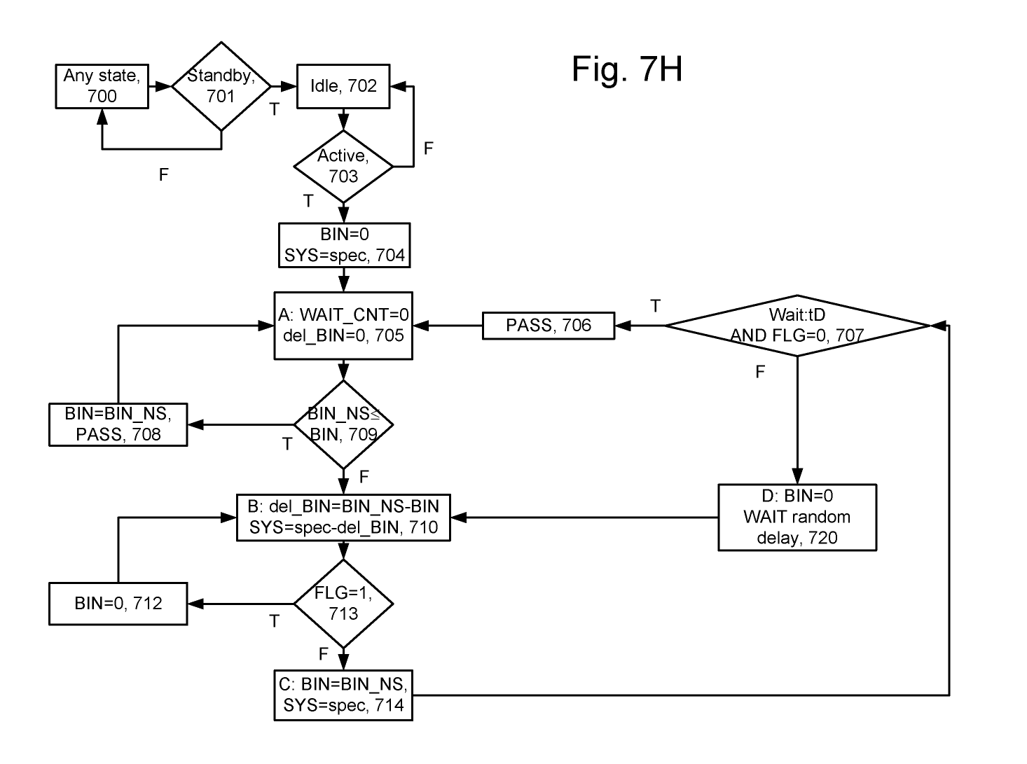

FIG. 7A depicts an example peak Icc detection algorithm using an arbitration process. The process may be performed at the state machine on each device. The state machine does scheduling for internal operations on each device based on the value of FLG, the output of the Icc detection circuit or comparator, Bin_CS (the present state Icc, e.g., Bin_Peak_Icc<1:0>) and Bin_NS (the next state Icc). In the figure, BIN represents the Bin_Peak_Icc<1:0> bits which control the current dumped on the contact, WAIT_CNT is an internal counter which counts the number of times any device has waited due to low priority, Spec represents the Icc specification of the system, SYS represents Sys_Peak_Icc<2:0> which controls the voltage level of the reference node, and tD is the contact settling time.

In the flowcharts, T denotes true, F denotes false or fail, and P denotes pass.

The process begins at any state (block 700). If a standby state is true at decision step 701, an idle state is reached at block 702. If an active state is true at decision step 703, block 704 initializes BIN=0 and SYS=spec and block 705 initializes WAIT_CNT=0 and del_BIN=0 in a state A. del_BIN=0 is a delta or change in BIN, e.g., BIN_NS−BIN. Otherwise the idle state is maintained. Decision step 709 determines if BIN_NS is less than or equal to BIN. If decision step 709 is true, block 708 sets BIN=BIN_NS. This block is also reached if a pass status is set at block 706. In this case, the estimate current consumption in the next state is less than in the present state so the device can directly enter the next state without the concern of whether there is sufficient current available. The process then returns to block 705. If decision step 709 is false, block 710 sets del_BIN=BIN_NS−BIN (the additional current required by the new state relative to the present state) and SYS=spec-del_BIN (a reduction in SYS due to the additional current) in a state B. If decision step 713 is true (i.e., FLG=1), block 712 is reached where BIN=0 (the present value of current consumption is reset). If decision step 713 is false (i.e., FLG=0), block 714 is reached where BIN=BIN_NS (the present value of current consumption is set to the next state current consumption) and SYS=spec (the present value of SYS is reset to the specification level) in a state C.

Additionally, a decision step 707 determines if a wait has taken place over the contact settling time tD and FLG=0. tD is a specified period of time. If this decision step is true, a pass status is set at block 706 and block 705 is reached. If decision step 707 is false, a decision step 711 determines whether an arbitration process has a pass status (P). The arbitration process may run on clock cycle of tD, the contact settling time. This ensures that the contact voltages have settled during the process of arbitration. If there is a pass status, i.e., the device wins the arbitration and is allowed to go to the next, higher-current state, block 706 is reached. If there is a fail status, i.e., the device loses the arbitration and is not allowed to go to the next, higher-current state, block 715 is reached where BIN=0 and WAIT_CNT is incremented by one (as denoted by WAIT_CNT++) in a state D. Subsequently, block 710 is reached.

The arbitration process may use a linear or binary search algorithm, for example, as described further below. For a linear algorithm, there may be 32 cycles with one wait state for a 16-die stack, and for a binary algorithm there may be 5 cycles with one wait state for a 16-die stack.

Blocks 705, 710, 714 and 715 denote states A, B, C and D, respectively, of the state machine.

FIG. 7B depicts an example of the process of FIG. 7A where a next state requires a lower Icc than a present state. The blocks and steps shown in FIG. 7B are relevant in this case. In this first case, BIN_NS≦BIN at decision step 709 (where Bin denotes Bin_CS). When a device wants to perform a lower Icc operation, it can directly update the source current on the contact and proceed with the operation.

FIG. 7C depicts an example of the process of FIG. 7A where a next state requires a higher Icc than a present state and the requested current does not violate a system current specification. The blocks and steps shown in FIG. 7C are relevant in this case. In this second case, when a device wants to perform a higher Icc operation (and when PASS is reached at block 706), the reference current is reduced by the ΔIcc (del_BIN), the difference between the next state Icc and the present state Icc. This is an internal check before updating the current on the contact. If FLG=0 (decision step 713 is false), the reference voltage is less than the contact voltage, and the source current on the contact can be updated. Also, SYS is changed back to the original specification (block 714, SYS=spec). After this, the device waits for a time, tD (contact settling time) at decision step 707. If FLG remains 0 for the entire duration of tD, it is a PASS case (block 706 is reached) and the device can go ahead with the next operation.

FIG. 7D depicts an example of the process of FIG. 7A where a next state requires a higher Icc than a present state and the requested current violates a system current specification, so that an internal wait state is entered. In this third case, the device wants to perform a higher Icc operation (internal WAIT case). The reference current (SYS) is reduced by the ΔIcc (del_BIN) at block 710. This produces the same effect as increasing BIN by ΔIcc. This is an internal check before updating the current on the contact. If FLG=1 at decision step 713, the device cannot go to the higher Icc operation. BIN is updated to 0 at block 712, SYS is updated to spec-del_BIN at block 710 and the device waits until FLG becomes 0. Alternatively, instead of updating BIN to 0, BIN can remain in same state. SYS would also remain the same as before. The device waits until FLG becomes 0. By doing this, the device does not give up the Icc that it has already been allotted. A disadvantage is that it prevents other devices from using this current.

FIG. 7E depicts an example of the process of FIG. 7A where a next state requires a higher Icc than a present state and two devices request a higher current simultaneously, so that an arbitration process is started. In this fourth case, in case FLG goes high after updating BIN to a higher BIN_NS state, the expectation is that after passing an internal check, and updating BIN to a higher value, FLG should continue to remain 0. But, in case two or more devices update BIN at the same time, or within a time duration of tD, FLG may transition from low to high. In this case, an arbitration process decides which of the two (or more) devices can go ahead with the next higher-current operation.

FIG. 7F depicts an example of the process of FIG. 7E after a device achieves a pass status in the arbitration process. In this fifth case, the device obtains a higher priority over all or some other devices. The output of the arbitration process may be a PASS/FAIL for any given device. In case of PASS (block 706), the device goes ahead with the next high current operation.

FIG. 7G depicts an example of the process of FIG. 7E after a device achieves a fail state in the arbitration process. In this sixth case, the device has a lower priority than some or all other devices. In case of a FAIL output of the arbitration process (decision step 711), the device updates its BIN value to 0, increments its WAIT_CNT (block 715) and goes back to state-B (block 710). Alternatively, it can update BIN to BIN_CS so that the device holds on to the Icc budget that it has been allotted.

FIG. 7H depicts an example of the process of FIG. 7E where the arbitration process uses a random delay. As mentioned, when two or more devices update BIN simultaneously and FLG becomes high, an arbitration process decides which of these devices can enter the PASS status. Various options for the arbitration process include a random delay, a linear search algorithm and a binary search algorithm.

In the random delay arbitration, when FLG becomes 1 after updating BIN, each of the contesting devices set their Icc state to 0 and enter a wait state. The devices then enter a higher Icc state after a random delay. This greatly reduces the probability of the contesting devices probing for a higher Icc simultaneously the next time. The higher the maximum random delay, the lower the probability of the contesting devices updating Icc at the same time again. A lower delay reduces the wait time during arbitration.

The random delay arbitration process is represented at block 720 and state D. BIN is set to 0 and WAIT is performed using a random delay.

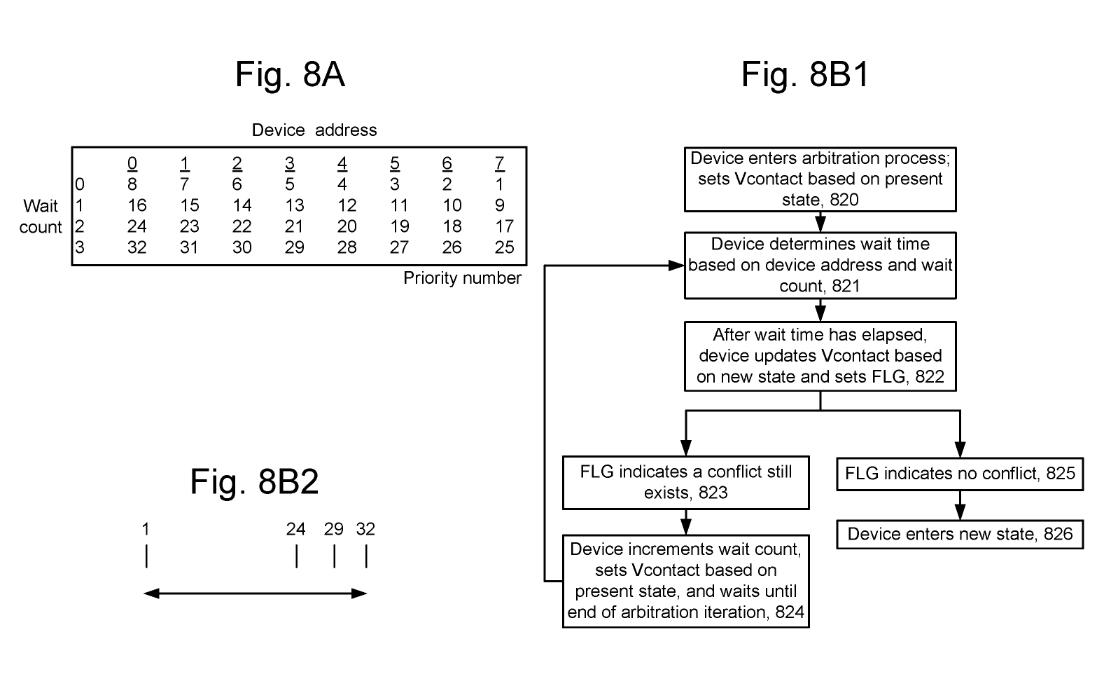

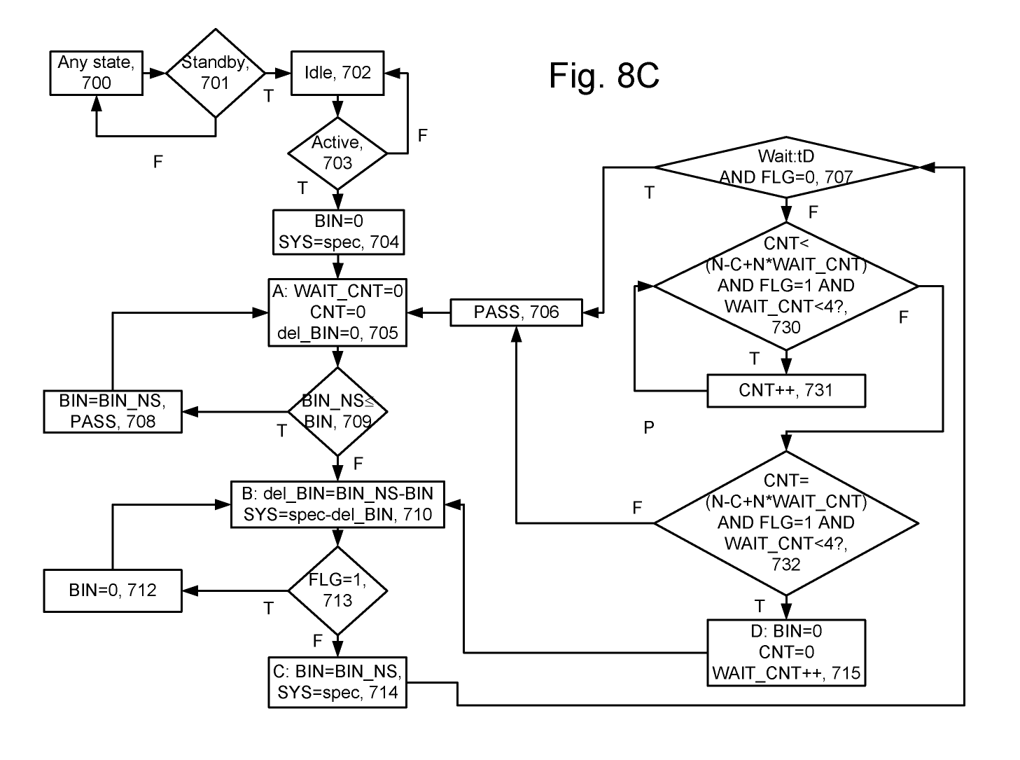

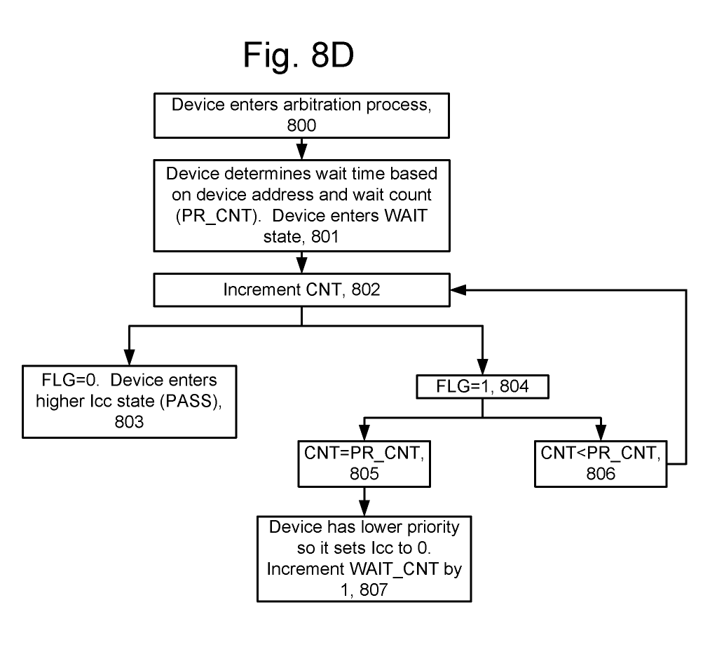

FIG. 8A depicts a matrix showing example priorities based on device address and wait count for use in a linear or binary search arbitration process. The rows represent different wait counts (WAIT_CNT) ranging from 0 to 3, the columns represent different device addresses ranging from 0 to 7 and the matrix values in the dashed box represent priorities ranging from 1 to 32 with a higher number representing a higher priority. The wait count (0 or more) is the number of times a device has lost in the arbitration process. By assigning a different priority based on device address, the arbitration process can choose a winner even when all devices have a same wait count. Since the device address is unique to each device, the priority for each device is unique. In one approach, the priority of a devices is: N−C+N*WAIT_CNT, where N is the number of devices, C is the device address (e.g., 0−w−1 for w devices).

WAIT_CNT is the number of times a device had to go back to state-B (block 710 in FIG. 7A) due to low priority. Increasing the maximum value of WAIT_CNT increases the total time for polling. For example, if N=8, the device address=0 and the WAIT_CNT=2, the priority is 8−0+8*2=24. In the linear search arbitration, the priority represents the amount of time (e.g., number of clock cycles) a device will wait before checking the flag to determine if it can enter the higher-current state.

The allocation of a unique priority for each combination of device and wait state ensures that a single device wins the arbitration process.

FIG. 8B1 depicts an example linear search arbitration process consistent with FIG. 8A. At step 820, the device enters the arbitration process and sets Vcontact based on the current consumption of the present state (BIN_CS). At step 821, the device determines the wait time based on the device address and wait count. In this step, wait time is set as max wait time−wait time determined in FIG. 8A. At step 822, after the wait time has elapsed, the device updates Vcontact based on the new state (BIN_NS) and sets FLG. At step 823, FLG=1 indicates a conflict still exists. In this case, at step 824, the device increments the wait count, sets Vcontact based on the present state, and waits until the end of the current iteration of the arbitration process. At step 825, FLG=0 indicates no conflict exists. In this case, at step 826, the device enters the higher-current state.

FIG. 8B2 depicts a time line of an arbitration process, consistent with FIGS. 8A and 8B1. For example, consider a contest between device 0 with WAIT_CNT=0 (priority 8) and device 5 with WAIT_CNT=0 (priority 3). The arbitration process has a duration of 32 units (e.g., clock cycles). The process begins at time=1. At a time=24 (32−8), device 0 updates BIN to BIN_NS and checks its flag to learn that FLG=0, and at time=29 (32−3), device 5 updates BIN to BIN_NS and checks its flag to learn that FLG=1. Device 0 can enter the next state at time=24. The arbitration process ends at time=32.

The arbitration process can be repeated in another iteration if necessary. See, e.g., step 558 of FIG. 5B. In this case, device 5 would have a priority of 11 since WAIT_CNT would be incremented to 1. Device 5 would therefore have an improved chance of winning the arbitration against whatever device it competes against in the next iteration.

FIG. 8C depicts another example of the linear search arbitration process consistent with FIG. 8A. Block 731 and decision steps 730 and 732 are new relative to FIG. 7A. In this approach, when FLG goes high after updating BIN, the device with the lower priority reduces its current (or makes it 0). After the lower priority device reduces its Icc, FLG becomes 0 for the higher priority device. This allows the higher priority device to proceed with its next operation. A device with a wait count beyond a specified value such as 2 or 3 can be allowed to proceed with the next operation directly, although this is a low probability event.

Decision step 730 determines if (CNT<N−C+N*WAIT_CNT) AND FLG=1 AND WAIT_CNT<4. If the decision step is true, CNT is incremented at block 731. CNT is a device address based counter which counts from 1 to (N−C+N*WAIT_CNT. This loop continues until decision step 730 is false, e.g., when CNT is sufficiently high, FLG=0 and/or WAIT_CNT>=4 or other maximum level. CNT is sufficiently high when the number of clock cycles for a device reaches the priority of the device. After that, the device waits until the arbitration process is complete, if the device has lost the arbitration process. If FLG=0 before CNT is sufficiently high, then the device is said to have won the arbitration. WAIT_CNT=4 when the device has waited the maximum number of times.

Subsequently, decision step 732 determines if (CNT=N−C+N*WAIT_CNT) AND FLG=1 AND WAIT_CNT<4. This is like the condition in decision step 730 except the < is replaced by =. If decision step 730 is false, the pass block 706 is reached, indicating that the device has won the arbitration and can enter the new state. See also block 708. Decision step 730 is false if CNT indicates the number of clock cycles for the device reaches the priority of the device, FLG=0 and/or WAIT_CNT>=4 or other maximum level.

If decision step 732 is true, the device loses the arbitration and block 715 sets BIN_CS=0 and CNT=0 and increments WAIT_CNT. The updated value of WAIT_CNT will be used in a next arbitration process for the device at decision steps 730 and 732.

FIG. 8D depicts another example of an arbitration process. At step 800, the device enters the arbitration process. At step 801, the device determines a wait time based on the device address and wait count (PR_CNT). The device also enters a WAIT state. Step 802 increments CNT. Subsequently, one of two paths is followed based on FLG. At step 803, FLG=0 and the device enters the higher Icc state. At step 804, FLG 1. If CNT=PR_CNT at step 805, step 807 is reached, where the device has a lower priority than other contesting devices so it sets Icc to 0. WAIT_CNT is incremented by one. At step 806, CNT<PR_CNT and step 802 follows.

Compared to the process of FIG. 8B, in the process of FIG. 8D, the wait time depends only on the priority of the contesting device and wait state. Basically if there is a priority 8 and 9, though the maximum priority may be 64 ((assuming 16 devices and 4 wait states), FLG goes low after cycle-8 and the arbitration process can end here. So, we save (64−9) cycles. But, in case of FIG. 8B, we need to wait until 64 cycles have completed. Another advantage of the process of FIG. 8D is that FLG going from 1 to 0 serves as a handshake between devices to convey that the arbitration process has ended. In FIG. 8B there is no such handshake so that the devices determine that the arbitration process has ended by counting the maximum number of clock cycles.

FIG. 9A1 depicts a tree showing a priority threshold of selected (device, wait state) pairs in a binary search arbitration process where there are 32 possible (device, wait state) pairs. The example is consistent with the priority numbers shown in FIG. 8A. In FIGS. 9A1 and 9A2, the numbers in the boxes represent a priority threshold for use in selecting (device, wait state) pairs in successive iterations (denoted by an index n) of the process. If a device has a (device, wait state) pair >= the priority threshold, the device is selected. See also FIG. 9B. Further, the priority threshold can increase or decrease in the successive iterations based on FLG. The priority threshold decreases if FLG=1 and increases if FLG=0. The amount of the increase or decrease is 2̂(m−n), where 2̂m is the total number of (device, wait state) pairs. Here, m=5 and 2̂5=32. For example, for n=2, 3, 4 or 5, the number of (device, wait state) pairs decreases or increases by 8 (i.e., 2̂(5−2)), 4 (i.e., 2̂(5−3)), 2 (i.e., 2̂(5−4)) or 1 (i.e., 2̂(5−5)), respectively.

FIG. 9A2 depicts a tree showing a priority threshold of selected (device, wait state) pairs in a binary search arbitration process where there are 16 possible (device, wait state) pairs. Here, m=4 and 2̂4=16. For example, for n=2, 3 or 4, the number of (device, wait state) pairs decreases or increases by 4 (i.e., 2̂(4−2), 2 (i.e., 2̂(4−3)) or 1 (i.e., 2̂(4−4)), respectively.

FIG. 9B depicts an example binary search arbitration process consistent with FIGS. 9A1, 9A2 and 9C. At step 910, a device updates Vcontact when FLG=0 but FLG=1 after a settling time. At step 911, the binary search arbitration process begins. This includes setting n=1 (iteration # of the process), m=# of (device, wait state) pairs and CNT=2̂(m−n), where CNT is the priority threshold. Step 912 selects (device, wait state) pairs with a priority>CNT. Step 913 unselects (device, wait state) pairs with a priority <= CNT. At step 914, if a contesting device is selected, the device updates Vcontact based on the new state and then checks FLG. At step 915, if a contesting device is unselected, it is not allowed to update Vcontact based on the new state. If it is in the new state, it returns to the old state. At step 916, if a contesting device is selected and FLG=0, the PASS status is set for the device and it enters the new state (the device wins the arbitration). The device is not termed as a contesting device after this. At step 917, if FLG=0 (no conflict), CNT=CNT+2̂(m−n). At step 918, if FLG=1 (conflict), CNT=CNT−2̂(m−n).

A decision step determines if the process is on the last iteration. If decision step 920 is false, step 919 increments n and steps 912 follows in a next iteration. If decision step 920 is true, step 921 sets a FAIL status for the device if a PASS status has not been set previously in the process (the device loses the arbitration).

Thus, the state machine is configured to perform an arbitration process if the flag transitions from the first value (0) to the second value (1) before a specified period of time (e.g., a contact settling time) expires, indicating a conflict between two or more of the devices. The arbitration process may comprise a binary search which is completed in m clock cycles of the state machine, where 2̂m is a number of the multiple devices multiplied by a number of wait states, and each wait state represents a number of times the one device has failed the arbitration process. The arbitration process may assign a unique priority to each combination of device and wait state, where each wait state represents a number of times each device has failed the arbitration process. For linear arbitration, the arbitration process ends when the flag transitions from the second value (1) to the first value (0), indicating no conflict between the devices. For binary arbitration, the arbitration process ends after m clock cycles.

FIG. 9C depicts an example of the binary search arbitration process of FIG. 9A. Pairs of (device, wait state) can be defined. The number of pairs in this example is 16, assuming eight devices and two wait states. Further, the process consumes m clock cycles, where 2̂m=number of pairs. In this example, m=4.

Initially all 16 pairs are selected. If FLG=1, then all devices enter the binary priority search algorithm. Let the cycle number be denoted by n. ‘n’ is incremented from 1 to 5. CNT is a counter which is initialized to 2̂m at the start of the algorithm. In every cycle, CNT is updated as: CNT=CNT+/−2̂(m−n). In each cycle +/− depends on FLG of the previous cycle. If FLG=1, ‘−’ is chosen. If FLG=0, ‘+’ is chosen. Statuses of each pair in each cycle depend on whether its priority (p) is > or <= CNT. If p>CNT, the status is “new state” and the device can update the contact if necessary. If p < or = CNT, the status is “previous state” and the device may revert to lower current state if necessary. For a contesting device, if status=new state and FLG=0 after settling time, it goes to a PASS state, and the device can go ahead with higher Icc operation. If FLG=1 and n=m, and the contesting device has not gone to the PASS status previously, then it will go to the FAIL state.

For a non-contesting device, if FLG =1, it knows that it needs to enter the WAIT state for ‘m’ cycles before carrying out any internal Icc check/contact update.

The maximum value of WAIT_CNT, max WAIT_CNT, can be configurable, but it should be set by a parameter during device-sort or based on a command through common interface. Max WAIT_CNT may be common between all devices. WAIT_CNT can range between 0 and max WAIT_CNT. The number of cycles in the binary priority search algorithm is defined by max WAIT_CNT. In general, it is very improbable to go to higher wait counts. Setting the max WAIT_CNT to two or three is sufficient in many implementations.

In this specific example, the table has rows 1-8 and columns (col.) 1-16. Row 1 identifies a combination of a device (D) and a wait state (W, also referred to as WAIT_CNT), e.g., as a data pair: (selected device, wait state). This example has eight devices (0-7) and two wait states, W=0 and 1. If additional wait states are being used, the table will have additional columns. The number of columns is number of devices multiplied by the number of wait states. The binary search process can significantly reduce the duration of the arbitration process, compared to the linear search. For example, the binary search can be completed in four clock cycles (rows 4-7) in this example compared to 16 clock cycles for a comparable linear search. Generally, the binary search can be completed in m clock cycles, where 2̂m is the number of different (selected device, wait state) pairs or combinations. 2̂m is also is a number of devices multiplied by a number of wait states, where each wait state represents a number of times the device has failed the arbitration process.

Row 2 identifies a priority of a device, similar to what was provided at FIG. 8A, where a higher number represents a higher priority. This example also notes that the contesting devices are CD1 (device 4, W=0) and CD2 (device 3, W=0).

Rows 3-7 each indicate a requested current BIN in a respective clock cycle, where BIN=BIN_CS is a current of a present state (CS=current state or present state), and BIN_NS is a current of a next (new), higher-current state. Rows 3-7 each represent one clock cycle which may be approximately equal to the contact settling time tD. A value of FLG is also indicated. The value of FLG value in each row is a result of the sum of Icc in same row.

Row 8 indicates a final result of pass or fail for the contesting device in the arbitration process.

A contesting device is one that wishes to go to a state that has a higher Icc requirement compared to current state. It is indicated by setting BIN=BIN_NS. All other (device, wait state) pairs continue to remain in the same Icc state, as indicated by BIN=BIN_CS.

A box is provided in each row for each (device, wait state) pair. A box can be shaded or unshaded. The shaded boxes represent selected (device, wait state) pairs. The binary search changes the selected (device, wait state) pair in each iteration, as discussed in FIG. 9B. A shaded box for a contesting (device, wait state) pair indicates the device can remain in the high Icc state (BIN=BIN_NS). An unshaded box for a contesting (device, wait state) pair indicates the device enters a wait state and its requested current is therefore updated by BIN=0. Alternatively, a contesting die in an unshaded box may also be updated to BIN=BIN_CS if it wishes to hold on to the current that it has already been allocated. Though this may help expedite the process of this die going to a higher current state, the disadvantage is that other die cannot make use of the quota of current that the given die is holding onto. A non-contesting (device, wait state) pair represents a device which maintains BIN=BIN_CS.

A value of priority (p) is generated by priority logic described earlier (FIG. 8C). A higher priority corresponds to a higher ‘p’.

With max priority state=16, the priority between any two or more contesting devices is decided in only 4 cycles. If number of devices is 16 or 32, only one or two more cycles are needed.

Initially FLG=0. At this stage, devices 3 and 4 with wait state 0 have updated Icc on the contact simultaneously, resulting in FLG=1 in Row 3. The arbitration process thus begins with a first iteration (n=1) in Row 4. In Row 4, both contesting devices have unshaded boxes indicating they are not selected; hence they update BIN=0. This changes FLG to 0 at Row 4. The second iteration is depicted in Row 5. In Row 5, device 3 updates its BIN to BIN_NS since it has a shaded box and is thus selected. After this, FLG remains at 0 in Row 5. This means that device 3 can go ahead with the next higher Icc operation and it moves to the pass status in Row 6. The third iteration is depicted in Row 6. In Row 6, device 4 has a shaded box and is thus selected, so it updates BIN=BIN_NS. As a result, FLG=1 in Row 6. The fourth and last iteration is depicted in Row 7. In Row 7, device 4 has a shaded box and is thus selected, so it retains BIN=BIN_NS. As a result, FLG=1 in Row 7. As a result, device 4 cannot go ahead with its high Icc operation and enters the fail state at Row 8.

The techniques provided herein improve system performance by efficient peak current management of a set of devices, allowing more devices to operate in parallel. The techniques are achieved by managing timing of internal operations in a device, where these internal operations are not accessible to a controller external to the device, in one approach. Further, one embodiment uses only one contact for current management. For example, an existing test contact can be reused for this purpose. Hence, there is no requirement of adding a new contact.

Moreover, peak current management can be performed independently on the device. Hence, there is no change in an interface specification between the device and a controller, and no involvement of the controller. System peak current specification can be set using parameters, and this can vary different for different systems. Another advantage is that no current is consumed by the peak Icc detection circuit on the device when it is in a standby mode.

Further, all active devices in the system are always aware of the total Icc consumed by the set of devices. If a device wants to go to a higher Icc state, it can quickly check the feasibility of doing this by reducing the internal specification rather than updating Icc on the contact. This avoids waiting for the contact voltage to settle each time such a check is made. This makes the process of checking for Icc budget a continuous event rather than a process that needs to be repeated at every fixed interval. The checking can be repeated at the internal state machine frequency, for instance. This also ensures that the external I/O (e.g., the load bus) is not disturbed unless a device actually goes to a higher Icc state.

System Icc specification and a device's Icc state are controlling voltage levels of two different nodes. This provides a wider voltage range, more noise margin and flexibility in design, compared to a case where the Icc state and specification are controlling voltage levels on the same node and reference voltage level is fixed.

The output of an internal comparator of a non-contesting device goes high only when two or more devices request a higher Icc simultaneously. This is a low probability event and triggers the arbitration process. The techniques described avoid triggering an arbitration process when only one device is requesting a higher Icc. The arbitration process can uses a binary search algorithm to arbitrate between two or more devices which request a higher Icc at the same time. The arbitration process takes into account the number of times a device had to wait.

In another approach which reduces complexity, random delay arbitration process can be used.

Another advantage is that, if two or more devices are contesting for a higher Icc at the same time and the total Icc for all devices is within the system specification, they can go to the higher Icc state simultaneously. Wait time is needed only when the system specification is violated.

In implementing the technique on a device, the logic complexity is modest since the addition of Icc of all devices is done in an analog circuit.

In a further aspect, if a certain operation cannot be supported due to Icc constraints, the operation can be slowed down instead of stopping. This can be done internally within the device without involvement of the contact. This is done by lowering the specification by a smaller ΔIcc if FLG of the contesting device becomes 1. See also step 559 of FIG. 5B.

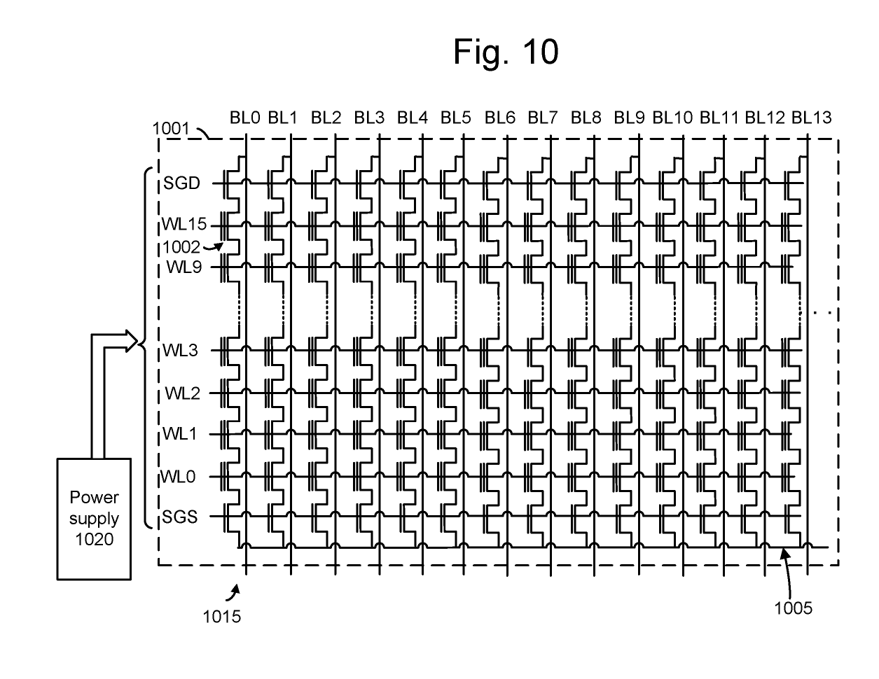

FIG. 9D is a block diagram of a non-volatile memory system using single row/column decoders and read/write circuits, as an example of the device of FIG. 1. The system may include many blocks of storage elements. A memory device 1020 has read/write circuits for reading and programming a page of storage elements in parallel, and may include one or more memory devices 1002. Memory device 1002 includes a two-dimensional array 1000 of storage elements, which may include several of the blocks 1001 of FIG. 10, control circuitry 1010, and read/write circuits 1065. In some embodiments, the array of storage elements can be three dimensional. The memory array is addressable by word lines via a row decoder 1030 and by bit lines via a column decoder 1060. The read/write circuits 1065 include multiple sense blocks 1001 and allow a page of storage elements to be read or programmed in parallel. Typically a controller 1050 is included in the same memory device (e.g., a removable storage card) as the one or more memory devices 1002. Commands and data are transferred between the host 1099 and controller 1050 via lines 1022 and between the controller and the one or more memory devices 1002 via lines 1021.

The control circuitry 1010 cooperates with the read/write circuits 1065 to perform operations on the memory array. The control circuitry 1010 includes a state machine 1012, an on-chip address decoder 1014 and a power control circuit 1016. In an example embodiment, the power control circuit 1016 is a step-down regulated charge pump for supplying a logic voltage, e.g., 1.2 V logic, in a non-volatile storage product. In another example embodiment, the power control circuit 1016 is a step-up regulated charge pump which supports a 1.8 V host in a non-volatile storage product.

The state machine 1012 provides chip-level control of memory operations. For example, the state machine may be configured to perform read and verify processes. The on-chip address decoder 1014 provides an address interface between that used by the host or a memory controller to the hardware address used by the decoders 1030 and 1060. The power control circuit 1016 controls the power and voltages supplied to the word lines and bit lines during memory operations.

In some implementations, some of the components of FIG. 9D can be combined. In various designs, one or more of the components (alone or in combination), other than memory array 1000, can be thought of as a managing or control circuit. For example, one or more managing or control circuits may include any one of, or a combination of, control circuitry 1010, state machine 1012, decoders 1014/960, power control 1016, sense blocks 1001, read/write circuits 1065, controller 1050, host controller 1099, and so forth.

The data stored in the memory array is read out by the column decoder 1060 and output to external I/O lines via the data I/O line and a data input/output buffer. Program data to be stored in the memory array is input to the data input/output buffer via the external I/O lines. Command data for controlling the memory device are input to the controller 1050. The command data informs the flash memory of what operation is requested. The input command is transferred to the control circuitry 1010. The state machine 1012 can output a status of the memory device such as READY/BUSY or PASS/FAIL. When the memory device is busy, it cannot receive new read or write commands.

In another possible configuration, a non-volatile memory system can use dual row/column decoders and read/write circuits. In this case, access to the memory array by the various peripheral circuits is implemented in a symmetric fashion, on opposite sides of the array, so that the densities of access lines and circuitry on each side are reduced by half

FIG. 10 depicts a block 1001 of memory cells in an example configuration of the memory array 1000 of FIG. 9D. As mentioned, a charge pump provides an output voltage which is different from a supply or input voltage. In one example application, a power supply 1020 is used to provide voltages at different levels during erase, program or read operations in a non-volatile memory device such as a NAND flash EEPROM. In such a device, the block includes a number of storage elements which communicate with respective word lines WL0-WL15, respective bit lines BL0-BL13, and a common source line 1005. An example storage element 1002 is depicted. In the example provided, sixteen storage elements are connected in series to form a NAND string (see example NAND string 1015), and there are sixteen data word lines WL0 through WL15. Moreover, one terminal of each NAND string is connected to a corresponding bit line via a drain select gate (connected to select gate drain line SGD), and another terminal is connected to a common source 1005 via a source select gate (connected to select gate source line SGS). Thus, the common source 1005 is coupled to each NAND string. The block 1001 is typically one of many such blocks in a memory array.

In an erase operation, a high voltage such as 20 V is applied to a substrate on which the NAND string is formed to remove charge from the storage elements. During a programming operation, a voltage in the range of 12-21 V is applied to a selected word line. In one approach, step-wise increasing program pulses are applied until a storage element is verified to have reached an intended state. Moreover, pass voltages at a lower level may be applied concurrently to the unselected word lines. In read and verify operations, the select gates (SGD and SGS) are connected to a voltage in a range of 2.5 to 4.5 V and the unselected word lines are raised to a read pass voltage, Vread, (typically a voltage in the range of 4.5 to 6 V) to make the transistors operate as pass gates. The selected word line is connected to a voltage, a level of which is specified for each read and verify operation, to determine whether a Vth of the concerned storage element is above or below such level.

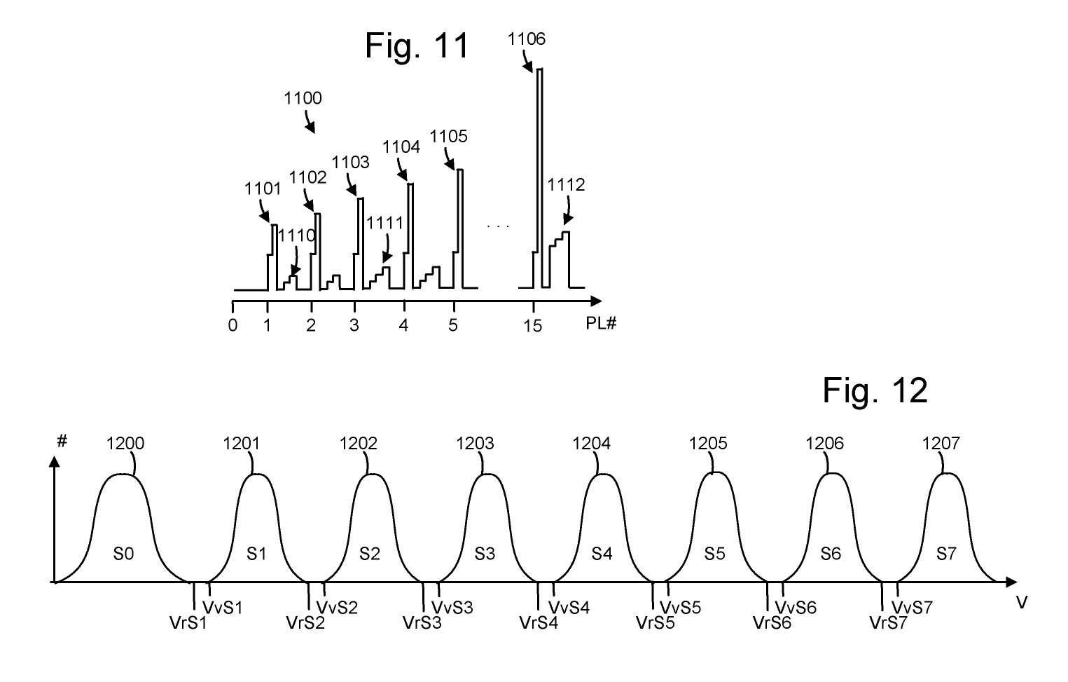

FIG. 11 depicts an example waveform in a programming operation using program and verify voltages which are provided by a power supply. The horizontal axis depicts a program loop (PL) number and the vertical axis depicts control gate or word line voltage. Generally, a programming operation can involve applying a pulse train to a selected word line, where the pulse train includes multiple program loops or program-verify iterations. The program portion of the program-verify iteration comprises a program voltage, and the verify portion of the program-verify iteration comprises one or more verify voltages.

Each program voltage includes two steps, in one approach. Further, Incremental Step Pulse Programming (ISPP) is used in this example, in which the program voltage steps up in each successive program loop using a fixed or varying step size. This example uses ISPP in a single programming pass in which the programming is completed. ISPP can also be used in each programming pass of a multi-pass operation.

The waveform 1100 includes a series of program voltages 1101, 1102, 1103, 1104, 1105, . . . 1106 that are applied to a word line selected for programming and to an associated set of non-volatile memory cells. One or more verify voltages can be provided after each program voltage as an example, based on the target data states which are being verified. 0 V may be applied to the selected word line between the program and verify voltages. For example, S1- and S2-state verify voltages of VvS1 and VvS2, respectively, (waveform 1110) may be applied after each of the program voltages 1101 and 1102. S1-, S2- and S3-state verify voltages of VvS1, VvS2 and VvS3 (waveform 1111) may be applied after each of the program voltages 1103 and 1104. After several additional program loops, not shown, S5-, S6- and S7-state verify voltages of VvS5, VvS6 and VvS7 (waveform 1112) may be applied after the final program voltage 1106.

FIG. 12 depicts example Vth distributions of memory cells for a case with eight data states, showing read and verify voltages which may be provided by a power control circuit. This example has eight data states, S0-S7. The S0, S1, S2, S3, S4, S5, S6 and S7 states are represented by the Vth distributions 1200, 1201, 1202, 1203, 1204, 1205, 1206, 1207, respectively, have verify voltages of VvS1, VvS2, VvS3, VvS4, VvS5, VvS6 and VvS7, respectively, and have read voltages of VrS1, VrS2, VrS3, VrS4, VrS5, VrS6 and VrS7, respectively. Pass voltages may also be provided by. A pass voltage is high enough to provide a memory cell in a strongly conductive state.

Accordingly, in one embodiment, an apparatus comprises: a comparison circuit having a first contact connected to a load bus and having a second contact connected to a power supply line; and a state machine in communication with the comparison circuit, the state machine configured to generate a comparison value based on system specification which has been pre-configured on non-volatile memory during device-sort or based on a command issued by a controller. The state machine is also configured to generate an estimated current consumption for a next state and configured to operate the comparison circuit to compare the comparison value to a value of the first contact, wherein the power supply line and the load bus are common to multiple devices.

In another embodiment, a method comprises: receiving a command to enter a next operation at a device, the command is received from a controller which is external to the device; internal command sequencing done by an on-chip state machine; the state machine determining a difference between an estimated current consumption of the next state and an estimated current consumption of a current state; decreasing a system specification current by the difference to provide an adjusted system specification current; providing a comparison value based on the adjusted system specification current; comparing the comparison value to a value of a load bus, the load bus shared by multiple devices; and based on the comparing, deciding whether to update difference current on load bus and enter the next state.

In another embodiment, an apparatus comprises: means for providing power to a set of devices using a common power supply line; means for connecting contacts of each device of the set of devices with one another; and means for instructing a device of a set of devices to transition from a present state to a next state, wherein the next state consumes more current than the present state, and the one device, to determine whether the power is sufficient to allow the device to transition from the present state to the next state, is configured to generate a comparison value based on an estimated current consumption for the next state, and compare the comparison value to a value of the means for connecting.

The foregoing detailed description of the invention has been presented for purposes of illustration and description. It is not intended to be exhaustive or to limit the invention to the precise form disclosed. Many modifications and variations are possible in light of the above teaching. The described embodiments were chosen to best explain the principles of the invention and its practical application, to thereby enable others skilled in the art to best utilize the invention in various embodiments and with various modifications as are suited to the particular use contemplated. It is intended that the scope of the invention be defined by the claims appended hereto.

What is claimed is:

1. An apparatus, comprising:
a comparison circuit having a first contact connected to a load bus and having a second contact connected to a power supply line; and
a state machine in communication with the comparison circuit, the state machine configured to generate a comparison value based on a system current specification and an estimated current consumption for a next state and configured to operate the comparison circuit to compare the comparison value to a value of the first contact, wherein the power supply line and the load bus are common to multiple devices.

2. The apparatus of claim 1, wherein:
the comparison circuit is configured to output a flag, the flag has a first value in response to the comparison value exceeding or being equal to the value of the first contact and a second value in response to the comparison value being lesser than the value of the first contact; and
the state machine is configured to transition from a first state to the next state in response to the flag having the first value for a specified period of time.

3. The apparatus of claim 2, wherein:
the state machine is configured to perform an arbitration process if the flag transitions from the first value to the second value before the specified period of time expires, indicating a conflict between two or more of the devices.

4. The apparatus of claim 3, wherein:
the comparison circuit, first contact, second contact and state machine are provided in each device of the multiple devices;
the arbitration process assigns a unique priority to each combination of device and wait state; and
each wait state represents a number of times each device has failed the arbitration process.

5. The apparatus of claim 4, wherein:
the arbitration process comprises a binary search which is completed in m clock cycles of the state machine, where 2̂m is a number of the multiple devices multiplied by a number of wait states, and each wait state represents a number of times a device has failed the arbitration process.

6. The apparatus of claim 4, wherein:
the arbitration process comprises a linear search which ends when the flag transitions from the second value to the first value, indicating no conflict between the devices.

7. The apparatus of claim 2, further comprising:
the specified period of time is a voltage settling time of the first contact.

8. The apparatus of claim 2, further comprising:
a current source, wherein the state machine is configured to use the current source to source a current onto the load bus during a specified period of time, and an amount of current sourced by the current source is equal to the estimated current consumption of the current state or next state, and a choice of current state or next state current is made based on a level of the flag.

9. The apparatus of claim 8, wherein:
the state machine, to use the current source to source the current onto the load bus, is configured to generate a multi-bit code representing the estimated current consumption of the current state or next state, to generate a current based on each bit of the multi-bit code and sum the generated currents.

10. The apparatus of claim 8, wherein:
the state machine is configured to use the current source to source the current onto the load bus without receiving a synchronizing signal from an external controller, external to the device.

11. The apparatus of claim 1, wherein:
the state machine is configured with a system specification current of the power supply line, an estimated current consumption of a present state, and an estimated current consumption of the next state, and the state machine, to generate the comparison value, is configured to decrease the system specification current by a difference between the estimated current consumption of the next state and the estimated current consumption of the current state, to provide an adjusted system specification current.

12. The apparatus of claim 11, wherein:
the adjusted system specification current is represented by a multi-bit code; and
the comparison circuit is configured to generate a current based on each bit of the multi-bit code and sum the currents to provide the comparison value at an input to a comparator.

13. The apparatus of claim 1, wherein:
the comparison circuit is configured to output a flag, the flag has a first value (0) if the comparison value exceeds or is equal to the value of the first contact and a second value (1) if the comparison value is lower than the value of the first contact; and
the state machine is configured to wait before transitioning from a present state to the next state if the flag has the second value.

14. The apparatus of claim 1, wherein:
the comparison circuit is configured to output a flag, the flag has a first value (0) if the comparison value exceeds or is equal to the value of the first contact and a second value (1) if the comparison value is lower than the value of the first contact; and
if the flag has the second value, the state machine is configured to determine whether to transition from a present state to another next state, where an estimated current consumption of the another next state is less than the estimated current consumption of the next state.

15. A method, comprising:
receiving a command to enter a next operation at a device, the command received from a controller which is external to the device;
determining an internal state of the device based on state machine sequencing;
determining a difference between an estimated current consumption of the next state and an estimated current consumption of a current state;
decreasing a system specification current by the difference to provide an adjusted system specification current;
providing a comparison value based on the adjusted system specification current;
comparing the comparison value to a value of a load bus, the load bus shared by multiple devices; and
based on the comparing, deciding whether to enter the next state.

16. The method of claim 15, wherein:
the deciding is performed by the device without receiving a synchronizing signal from the external controller.

17. The method of claim 15, further comprising:
based on the comparing, deciding to enter an arbitration process, wherein the arbitration process is performed on the device without involvement of the external controller.

18. The method of claim 15, wherein the deciding comprises determining whether the comparison value exceeds the value of the load bus for a specified period of time, the method further comprising:
entering the next state if the comparison value exceeds or equals the value of the load bus throughout the specified period of time; and
performing an arbitration process if the comparison value exceeds or equals the value of the load bus and then the comparison value is lower than the value of the load bus before an end of the specified period of time.

19. An apparatus, comprising:
means for providing power to a set of devices using a common power supply line;
means for connecting contacts of each device of the set of devices with one another; and
means for instructing a device of a set of devices to transition from a present state to a next state, wherein the next state consumes more current than the present state, and the one device, to determine whether the power is sufficient to allow the device to transition from the present state to the next state, is configured to generate a comparison value based on a system current specification and an estimated current consumption for the next state, and compare the comparison value to a value of the means for connecting.

20. The apparatus of claim 19, wherein:
each device is configured to source a different current onto the means for connecting without receiving a synchronizing signal, if the comparison value exceeds or equals the value of the means for connecting.
